(19) United States
(12) Patent Application Publication
(10) Pub. No.: US 2023/0355454 A1
(43) Pub. Date: Nov. 9, 2023

(54) PATIENT TRANSPORT SYSTEM

(71) Applicant: STEM S.R.L., MEDESANO (PR) (IT)

(72) Inventors: Ezio MENNA, COLLECCHIO (PR) (IT); Michele CORRADI, PARMA (IT)

(21) Appl. No.: 18/312,031

(22) Filed: May 4, 2023

(30) Foreign Application Priority Data
May 6, 2022 (IT) 102022000009314

(51) Int. Cl. A61G 7/10; A61G 1/02; A61G 1/013

(52) U.S. Cl. CPC A61G 7/1046; A61G 7/1013; A61G 1/02; A61G 7/1074; A61G 1/013

(57) ABSTRACT

A patient transport system (10) that comprises:
at least one mobile undercarriage (20) provided with rest wheels (221,231) and equipped with a fixing arrangement (252);
a plurality of additional devices (30) for supporting the patient, wherein the additional devices (30) of the plurality of additional devices are structurally different from each other;
wherein each additional device (30) is equipped with a relative fixing block (315), wherein each fixing block (315) is configured to selectively engage with the fixing arrangement (252) of the undercarriage (20), so that any one of the additional devices (30) can be selectively mounted on the same undercarriage (20) by means of the connection between the fixing arrangement (252) of the undercarriage (20) with the fixing block (315) of the respective additional device (30).

### TECHNICAL FIELD

The present invention relates to a patient transport system, preferably of a modular type.

### PRIOR ART

As is well known, there are various transport systems used for transporting patients, e.g. for loading and unloading and transporting them by means of emergency vehicles (such as ambulances).

Common patient transport systems include, for example, stretchers, bariatric stretchers, cots, neonatal cots, bio-containment cabins and otherwise.

Each of these transport systems is, however, a closed or independent system (i.e. substantially “stand-alone”), i.e. it has accessories and handling and ground rest arrangements dedicated to the single application for which they are intended. One need felt in the sector is to make each of these transport systems more versatile and variously configurable, so that a hospital or a facility for the treatment and/or transport of patients can be provided with a system that can be variously configured according to requirements.

An object of the present invention is to satisfy these and other needs of the prior art, with a simple, rational and low-cost solution.

These objects are achieved by the features of the invention set forth in the independent claim. The dependent claims outline preferred and/or particularly advantageous aspects of the invention.

### DISCLOSURE OF THE INVENTION

The invention, in particular, makes available a patient transport system that comprises:
at least one mobile undercarriage provided with rest wheels and equipped with a fixing arrangement;
a plurality of additional devices for supporting the patient, wherein the additional devices of the plurality of additional devices are structurally (and functionally) different from each other (e.g. distinguished on the basis of a functional type thereof);
wherein each additional device is equipped with a relative fixing block, wherein each fixing block is configured to engage selectively with the fixing arrangement of the undercarriage in a releasable manner, so that any one of the additional devices can be selectively mounted on the same undercarriage by means of the connection between the fixing arrangement of the undercarriage with the fixing block of the respective additional device.

Thanks to this solution, it is possible to satisfy the needs outlined above. In particular, it is possible to make available a complete and versatile equipment that adapts to the needs of the user and is comfortable to use.

Advantageously, the patient transport system may comprise a fleet of said undercarriages each equipped with a respective fixing arrangement selectively engageable by any one of the fixing blocks of the plurality of additional devices, including at least a first undercarriage of the fleet is of the semi-automatic or servo-assisted drive type and at least a second undercarriage of the fleet is of the manually operated type.

Still, each fixing block may be configured to engage releasably with the fixing arrangement by means of a snap coupling, wherein preferably the fixing arrangement comprises at least one coupling seat and each fixing block comprises at least one coupling pin suitable for engaging, in a snap releasable manner, with the coupling seat.

Advantageously, the coupling seat can comprise a lead-in and guide section for the coupling pin.

Still, the coupling seat may comprise a manually operable snap locking element for the release, preferably by means of a release lever.

According to an advantageous aspect, the fixing arrangement can be rigidly fixed to a load-bearing frame of the undercarriage.

In addition, each fixing block can be rigidly fixed to a load-bearing structure of the respective additional device.

According to an advantageous aspect of the invention, the additional devices may be chosen from the group consisting of a stretcher or gurney, a biocontainment cabin, a bariatric stretcher and a neonatal cot.

Advantageously, the plurality of additional devices may comprise at least a first additional device of a first functional type chosen from the group consisting of a stretcher or gurney, a biocontainment cabin, a bariatric stretcher and a neonatal cot, and at least a second additional device of a second functional type different from the first functional type and chosen from the group consisting of a stretcher or gurney, a biocontainment cabin, a bariatric stretcher and a neonatal cot.

According to an advantageous aspect of the invention, the undercarriage may comprise a system for recognising the functional type of the additional device that is mounted thereon.

Within the scope of this aspect, the recognition system may comprise a reader (e.g. a radio reader or an optical reader) configured to read at least one identified code of the additional device and/or of the functional type of the additional device applied to each additional device.

Still, within the scope of this aspect, the undercarriage may comprise:
a load-bearing frame;
legs articulated to the load-bearing frame; and
at least one actuation arrangement configured to move the legs with respect to the load-bearing frame;
wherein the undercarriage may further comprise:
an electronic control unit operationally connected to the recognition system and the actuation arrangement, wherein the electronic control unit is configured to:
determine the functional type of the additional device mounted on the undercarriage; and
(for example) check at least one operating parameter of the actuation arrangement on the basis of the determined functional type.

According to an independent aspect, the invention makes available a patient transport system that comprises:
a fleet of mobile undercarriages provided with ground rest wheels, including at least one automated first undercarriage and at least one manually operated second undercarriage;
a plurality of additional devices for supporting the patient;
a multiplicity of releasable and mutually equal fixing systems, wherein each fixing system is provided with a fixing arrangement and a fixing block, wherein each fixing arrangement is adapted to be engaged, in a releasable manner, selectively by any one of the fixing blocks;
   wherein each undercarriage of the undercarriage fleet is equipped with at least one fixing arrangement and each additional device is equipped with a relative fixing block, so that any one of the additional devices can be selectively mounted on each undercarriage of the undercarriage fleet by means of the respective fixing system.

Furthermore, a further independently protectable aspect made available by the invention provides for a patient transport system that comprises:
a fleet of mobile undercarriages provided with ground rest wheels, including at least one automated first undercarriage and at least one manually operated second undercarriage; and
a plurality of additional devices for supporting the patient;
   wherein any one of the additional devices may be selectively mounted on each undercarriage of the undercarriage fleet by means of an identical releasable (reciprocally interconnecting) fixing system.

### BRIEF DESCRIPTION OF THE DRAWINGS

Further features and advantages of the invention will be more apparent after reading the following description provided by way of non-limiting example, with the aid of the figures illustrated in the accompanying drawings.

FIG. 1 is an axonometric view of a system for loading/unloading according to the invention.

FIG. 2 is an exploded axonometric view of a system for loading/unloading according to the invention.

FIG. 3 is a first axonometric view of a first (type of) (semi-automatic) undercarriage of a patient transport system according to the invention.

FIG. 4 is a second axonometric view of the undercarriage of FIG. 3.

FIG. 5 is a side view of FIG. 3 with lowered or open legs.

FIG. 6 is a side view of FIG. 3 with raised or closed legs.

FIG. 7 is a schematic view of the undercarriage with some sensors of the sensor arrangement thereof highlighted.

FIGS. 8A and 8B are views in partial medial section of the undercarriage of FIG. 5.

FIGS. 9A and 9B are axonometric views of a portion of the legs of the undercarriage of the patient transport system according to the invention, respectively in the lowered position and in the raised position.

FIGS. 10A and 10B are sectional views of a leg (of FIG. 9A).

FIG. 11A is an anterior-inferior axonometric view of a coupling body of the undercarriage of a patient transport system according to the invention.

FIGS. 11B and 11C are sectional views of the coupling body of FIG. 11a.

FIGS. 12A-12D are sectional views of the coupling body of FIG. 11A in respective operating configurations.

FIG. 13 is a side (schematic) view of a second (type) of (manual) undercarriage of the transport system according to the invention.

FIG. 14 is an axonometric view of a loading/unloading apparatus of the system for loading/unloading according to the invention.

FIGS. 15A-15D are views of details of the loading/unloading apparatus of FIG. 14.

FIG. 16A is an axonometric view (from above) of an additional device of the invention, according to a first functional type.

FIG. 16B is an axonometric view (from below) of FIG. 16A.

FIG. 17A is a plan view (from above) of a load-bearing structure of an additional device of the invention.

FIG. 17B is an axonometric view (from above) of FIG. 17A.

FIG. 18A is an axonometric view (from above) of an additional device of the invention, according to a second functional type.

FIG. 18B is an axonometric view (from below) of FIG. 18A.

FIG. 19A is a plan view (from above) of an additional device of the invention, according to a third functional type.

FIG. 19B is an axonometric view (from below) of FIG. 19A.

FIG. 20 is a side view of an additional device of the invention, according to a fourth functional type.

FIGS. 21A-21C are axonometric views of a fixing assembly of an undercarriage according to the invention together with the fixing blocks of an additional device and the safety couplings of the loading/unloading apparatus, in various operating configurations.

FIG. 21D is a sectional view of a detail of FIG. 21A.

FIGS. 22A and 22B are axonometric views (from below and above, respectively) of a fixing arrangement of an undercarriage according to the invention.

FIG. 23 is a schematic view of a patient transport system according to the invention.

FIGS. 24A-24F are schematic views of a loading sequence of a patient transport equipment onto the loading/unloading apparatus.

FIGS. 25A-25D are schematic views of detail of the loading sequence (in particular of the coupling sequence between the coupling body and the support coupling and the subsequent unlocking of the support coupling).

FIGS. 26A-26F are schematic views of an unloading sequence of a transport equipment from the loading/unloading apparatus.

FIGS. 27A-27C are schematic views of detail of the unloading sequence (in particular, of the intermediate block of the loading/unloading apparatus and of the release sequence between the coupling body and the support coupling).

FIG. 28 is a side view of a transport equipment loaded onto and locked to the loading/unloading apparatus by means of the interconnection between the fixing assembly of the undercarriage and the safety couplings of the loading/unloading apparatus.

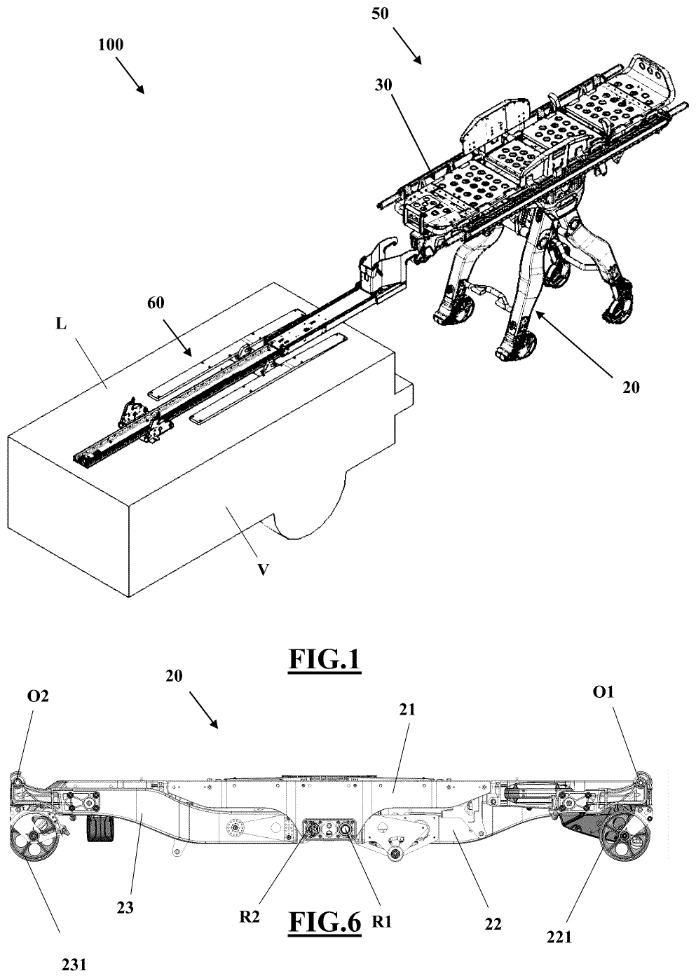

### BEST MODE TO IMPLEMENT THE INVENTION

With particular reference to these figures, a patient transport system, for example a patient transport system of the modular type, has been indicated globally with 10.

The patient transport system 10 is part of or configured to interact with a system for loading/unloading, referred to globally as the number 100.

The patient transport system 10 is an ambulance transport system, i.e. configured to be loaded/unloaded onto/from a loading surface L of an ambulance V, or other patient and emergency transport vehicle.

The loading surface L of the ambulance V is, for example, defined by the back wall of a rear loading compartment of the ambulance V, which is accessible at the rear through a rear opening of the ambulance V and which extends anteriorly in a longitudinal direction along the longitudinal axis of the ambulance V towards a driver's cab thereof.

The patient transport system 10 comprises at least one undercarriage 20, which is configured to sustain/support and constrain (and/or move) an additional device 30, which in turn is configured to sustain (directly) a patient, as will be better described below.

The undercarriage 20 preferably comprises a support frame 21 and a plurality of legs 22 and 23 articulated to the support frame 21 and provided with rest wheels.

In practice, the support frame 21 can be raised and/or lowered with respect to the rest plane defined by the rest wheels and/or tiltable with respect thereto.

The support frame 21 has a predominant longitudinal development (along a longitudinal axis) and comprises two opposing axial ends, including a front end and a rear end.

The front end is to be understood herein as the “loading end”, i.e., the axial end of the support frame 21 of the undercarriage 20 that is first loaded onto the loading surface L. The rear end is, on the other hand, the axial end of the support frame 21 of the undercarriage that is last loaded onto the loading surface L, and is to be understood as the “control end” which is the end that provides the grip and/or the commands for the operator to control the handling of the undercarriage 20. In addition, the undercarriage 20 is loaded with a patient, the patient's head can be oriented proximal to the front end and the patient's feet can be oriented proximal to the rear end. Therefore, the term “head side” can be used interchangeably with the term “front” and the term “feet side” can be used interchangeably with the term “rear”. In general, the term “patient” means any living or formerly living load such as, for example, a human being, animal or other that can be transported and/or loaded (indirectly) onto the undercarriage 20 for loading/unloading onto/from the loading surface L.

The support frame 21 is rigid, rigid being understood to mean capable of resisting (without apparent deformations when it is subjected to the loads that it is intended—in its own way—to support during use).

The support frame 21, in practice, defines the load-bearing frame of the undercarriage 20.

Preferably, the support frame 21 comprises an upper platform and a lower surface (in use facing the ground).

The upper platform of the support frame 21 is configured to define a (indirect) rest surface for the patient (i.e. through the additional device 30), as will be better described below.

Furthermore, the support frame 21 may comprise at least one handle bar 211, for example arranged at or near the rear end (and/or front end) of the support frame 21.

The handle bar 211 is configured to be grasped by one or two hands of an operator to operate the pushing or pulling of the undercarriage 20 and to operate a transport thereof and/or to guide it.

The undercarriage 20 comprises a fixing assembly 25, which is configured to interconnect (in a releasable manner) the undercarriage 20 to the system for loading/unloading 100 and to the additional device 30, as will be better clarified below.

The fixing assembly 25 comprises a rigid constraint body 250, which is rigidly fixed to the support frame 21 of the undercarriage 20.

The rigid constraint body 250 is non-deformable (to traction, bending and twisting) to the usual mechanical stresses to which it is subjected or for which it is designed and studied, in operation.

The rigid constraint body 250 comprises (or consists of) a fork-like frame (reinforced by a central beam) and has a first (upper) end and an opposing second (lower) end, which is for example bifurcated.

The rigid constraint body 250 is rigidly fixed, for example by a threaded connection or by welding or other fixing technique, to the support frame 21 at the first (upper) end thereof, so that its second (lower) end is substantially free (cantilevered).

The rigid constraint body 250, for example, is fixed to the support frame 21 so that its second (lower) end protrudes below it, i.e. protrudes below its lower surface.

Preferably, the fixing assembly 25 comprises a pair of rigid constraint bodies 250, including a front constraint rigid body 250, which is arranged at or near the front end (or head side) of the support frame 21, and a rear constraint rigid body 250, which is arranged at or near the rear end (or feet side) of the support frame 21.

Each constraint body 250 is provided, at the second (lower) end thereof, with a coupling body 251, for example defined by a rigid pin (or bar).

The coupling body 251, as will be better described below, is configured to be coupled, in a detachable manner, to the system for loading/unloading 100.

For example, the coupling body 251 (i.e. the rigid pin) is for example arranged with a longitudinal axis parallel to the upper platform and orthogonal to the longitudinal axis of the support frame 21.

For example, each constraint body 250 comprises a pair of coupling bodies 251 (i.e., rigid pins), one for each bifurcated second (lower) end.

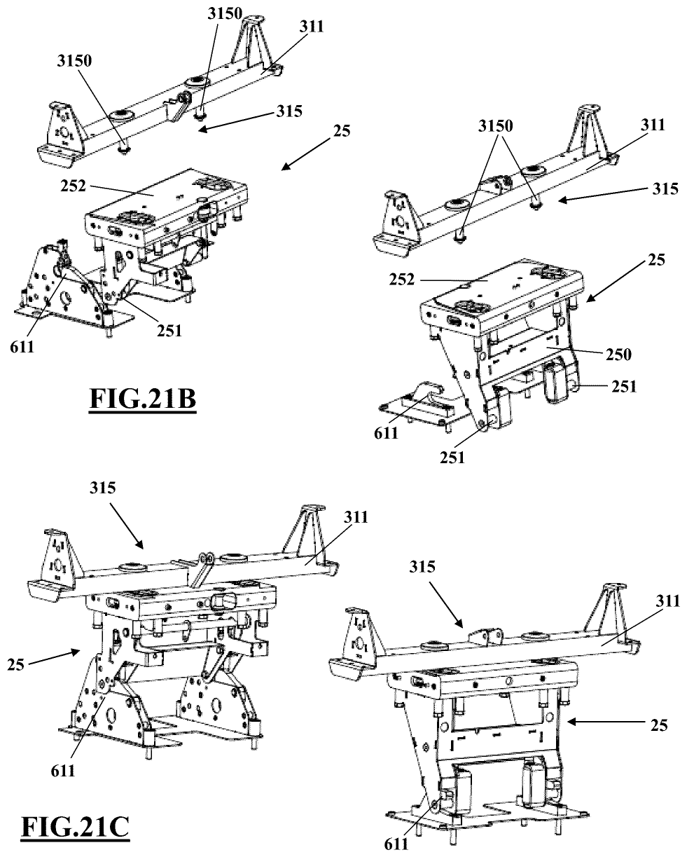

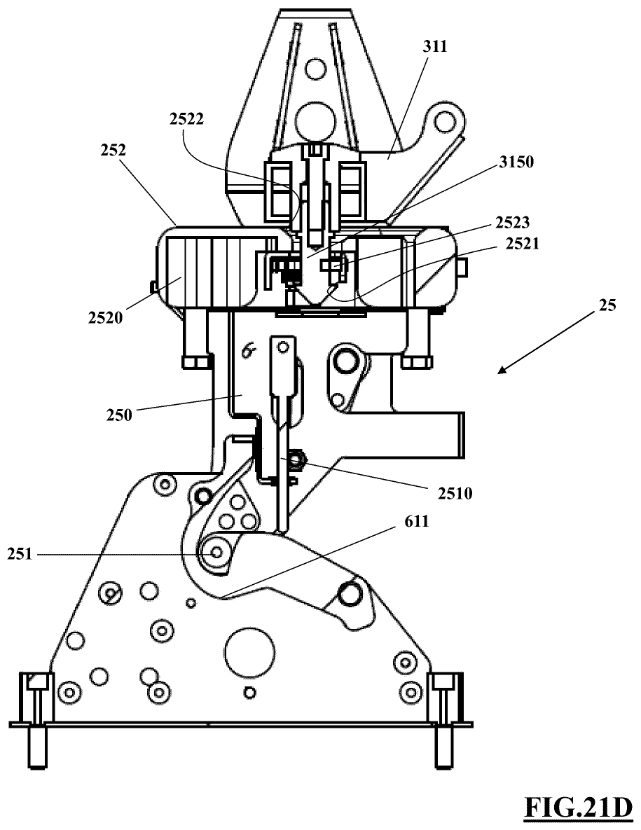

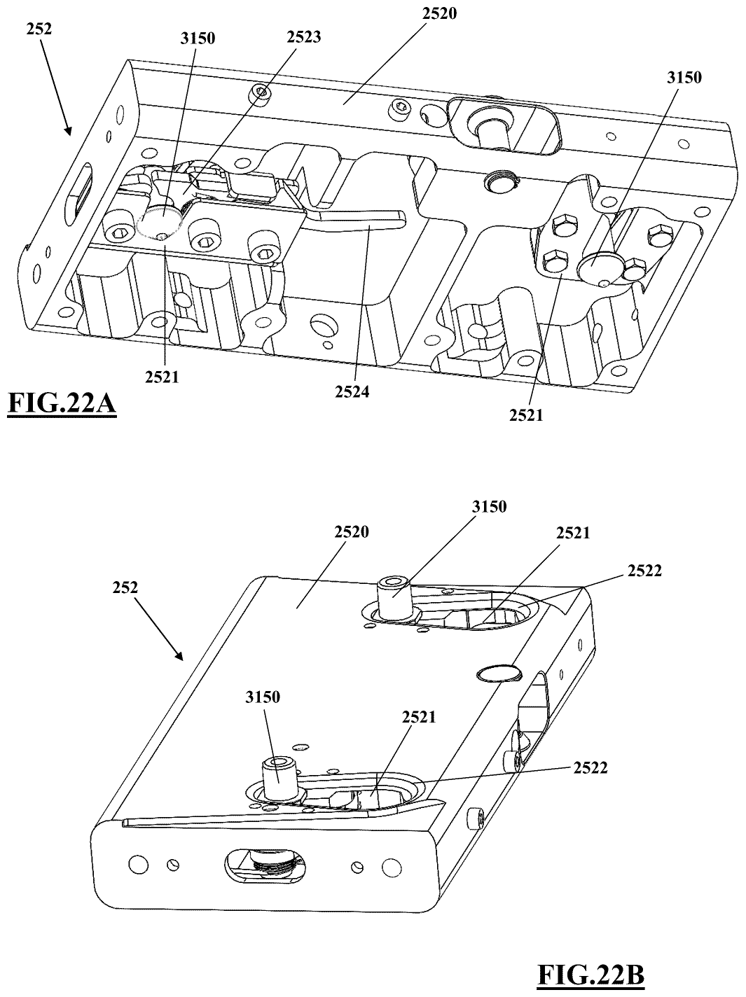

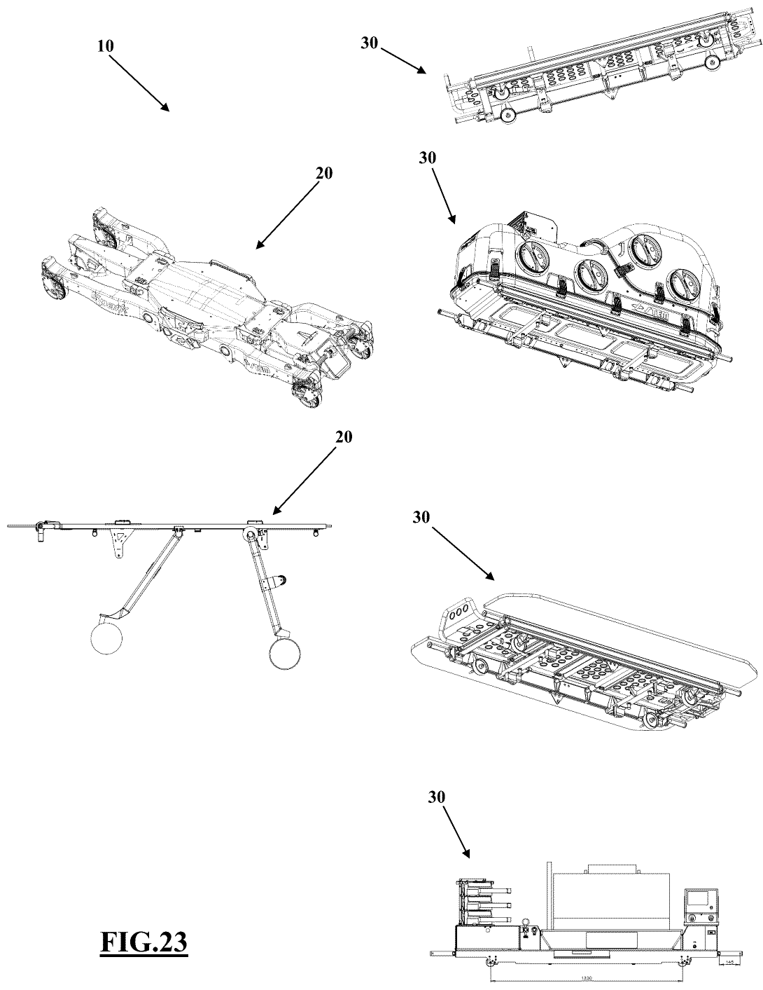

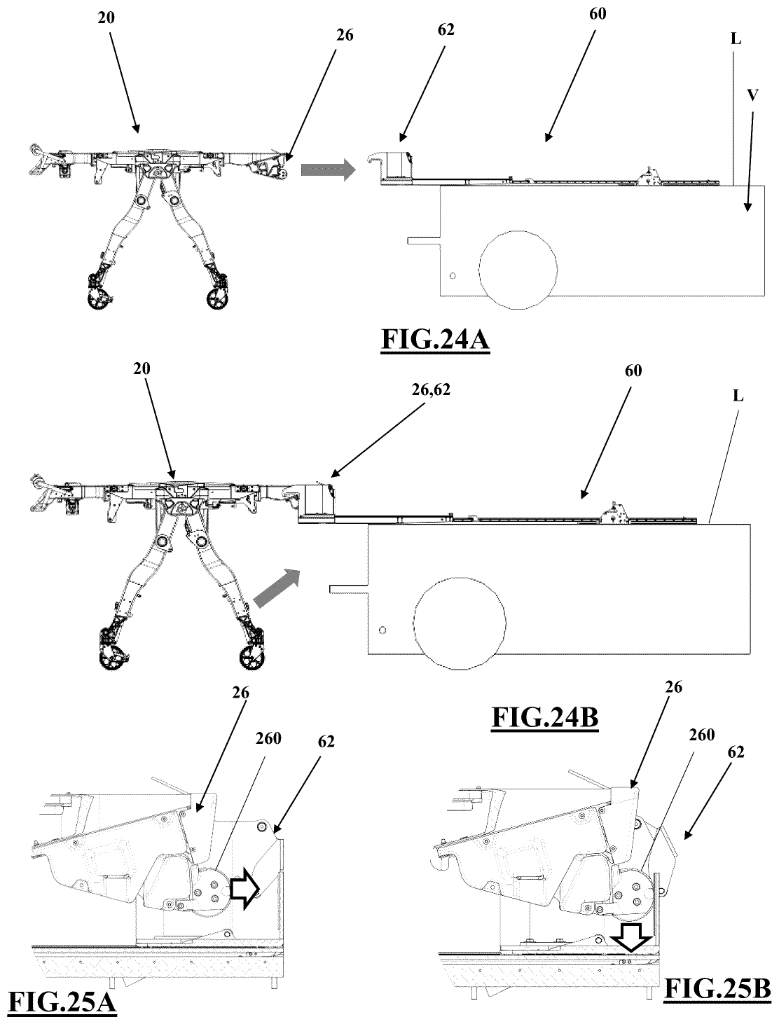

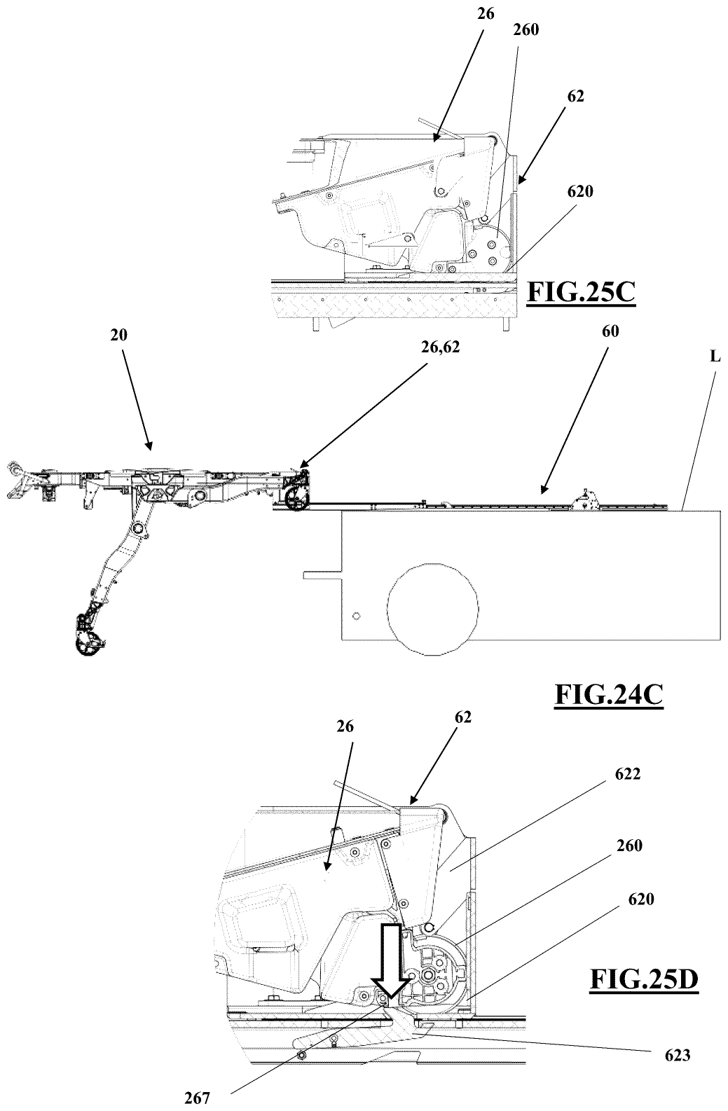

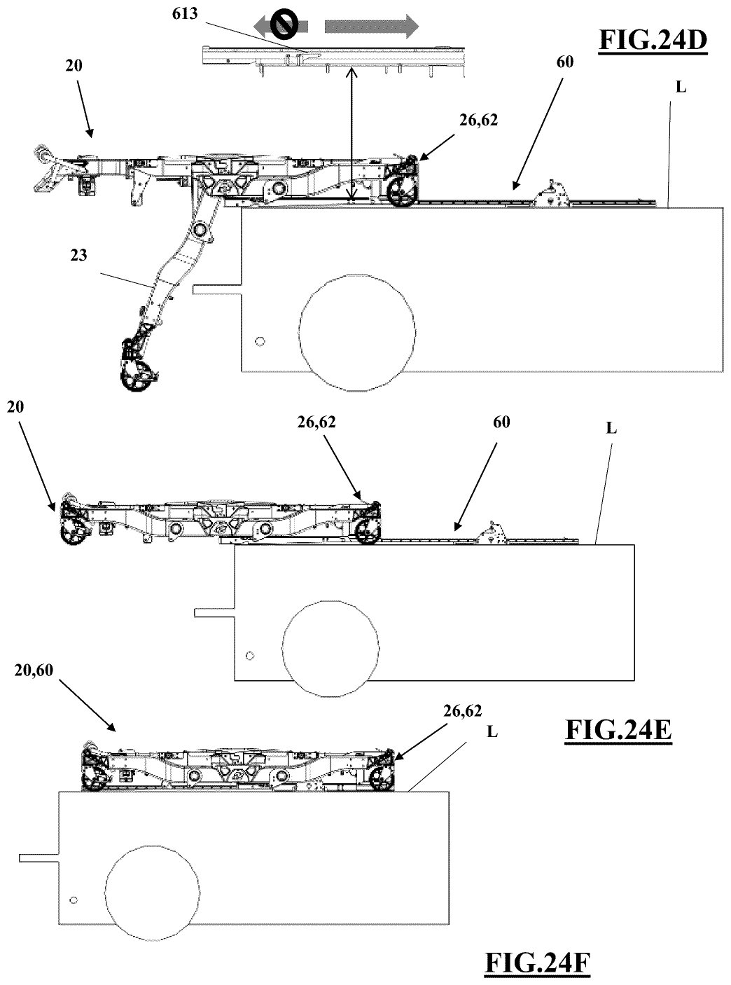

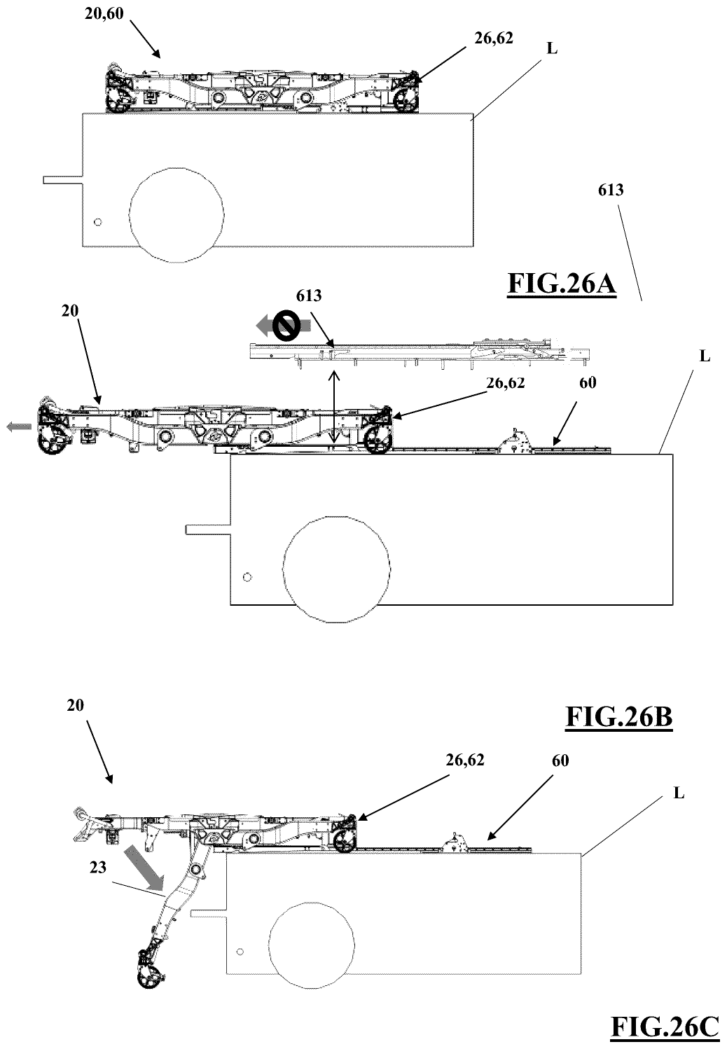

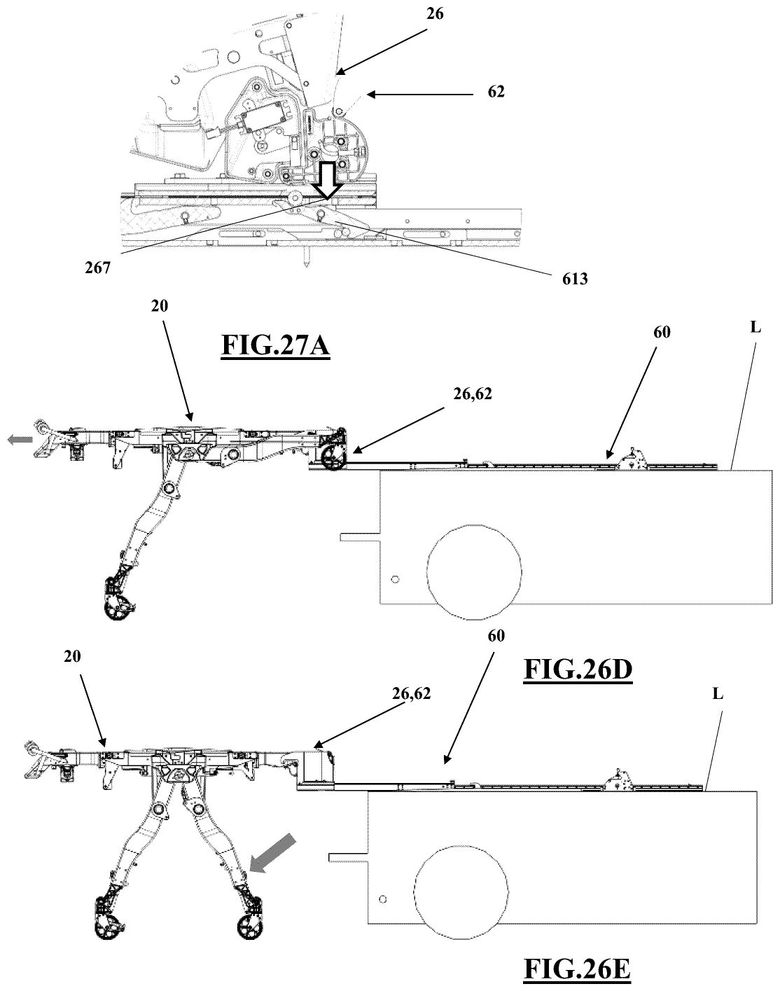

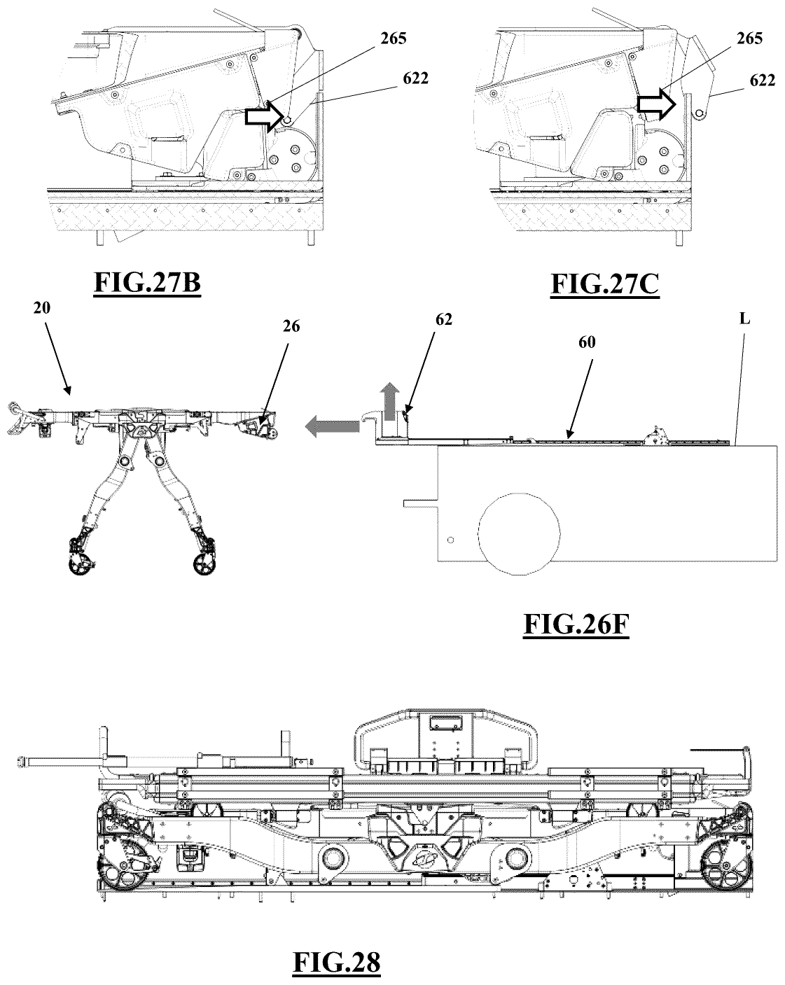

A release piston 2510 (see FIG. 21D), configured to free the coupling body 251 on command, can be connected to the rigid constraint body 250.

For example, the release piston 2510 is movable (vertically) between a lower active position and an upper inactive position.

In particular, the release piston 2510 is slidingly associated with the rigid constraint body and, therefore, with the support frame 21 along a sliding direction orthogonal to the (rest platform of) the support frame 21 and, between two vertical end stroke positions, defined by the lower active position and by the upper inactive position.

For example, the release piston 2510 is slidingly actuated, for example manually, preferably through a lever.

The fixing assembly 25 further comprises a fixing arrangement 252.

In detail, each constraint body 250 is provided, at the first (upper) end thereof, with a (respective) fixing arrangement 252.

Each fixing arrangement 252 is, for example, configured to be detachably engaged by an additional device 30, as will better appear later in the description.

Each fixing arrangement 252 comprises a plate 2520, for example defined by a rigid box-like (flat) body.

The plate 2520 (i.e., the box-like body thereof) is rigidly fixed, e.g., by threaded connections or by welding or other stable fixing technique, to the first (upper) end of the rigid constraint body 250.

For example, the plate 2520 has an upper face which is substantially coplanar (or flush) with the upper surface of the support frame 21 (i.e. seamlessly adjacent thereto).

Each fixing arrangement 252 comprises at least one coupling seat 2521, for example made in the plate 2520 and preferably open at the upper face thereof.

Preferably, each fixing arrangement 252 comprises a pair of coupling seats 2521 (identical to each other) flanked (and aligned or offset) with respect to a flanking direction parallel to the upper platform of the support frame 21 and orthogonal to the longitudinal axis of the support frame 21.

Each coupling seat 2521 comprises an access slot 2522, for example defined by a through hole made in the upper face, which for example has a conical opening defining a lead-in (and centring) section.

Each access slot 2522 has, for example, an elongated shape (with a longitudinal axis parallel to the longitudinal axis of the support frame 21) and, preferably, an irregular shape, i.e. having an enlarged (rear) axial section and an (adjacent) tapered axial (front) section, wherein the enlarged axial section has a greater width than the tapered axial section.

At least one fixing arrangement 252, for example the front or rear fixing arrangement only or both fixing arrangements, has a locking element 2523.

For example, the locking element 2523 is configured to define a lock (for the additional device 30) at an axial section of the coupling seat 2521 (i.e., the access slot 2522), for example at the tapered axial section of the access slot 2522.

The locking element 2523 comprises, for example, a “C”-shaped seat with a rearwardly facing concavity (i.e. towards the enlarged axial section) and a trigger-like closing element, which is operable by snapping and is manually operable for the release, preferably by means of a release lever 2524.

For example, the locking element 2523 could be provided in only one (or both) of the fixing seats 2521 of the fixing arrangement 252 (or of each fixing arrangement 252).

The release lever 2524 is accessible from the outside (i.e. from underneath the plate 2520) through an access opening and/or through a return member (not illustrated).

In particular, each rigid constraint body 250 substantially defines a single body with (or a body rigidly fixed to) the coupling body 251 and the fixing arrangement 252.

In other words, the fork-like frame of each rigid constraint body 250 stably joins the coupling body 251 and the fixing arrangement 252 (rigidly connecting them).

Preferably, the coupling body 251 and the fixing arrangement 252 are substantially aligned along an overlapping (vertical) direction orthogonal to the upper platform of the support frame 21 (defining the indirect rest surface for the patient) and/or to the loading surface L of the ambulance V, when the undercarriage 20 is loaded thereon.

In practice, the fork-like frame of each rigid constraint body 250 (which interconnects) the coupling body 251 and the fixing arrangement 252 develops along the overlapping direction.

Still, the (fork-like frame of the) constraint body 250 and/or the coupling body 251 are (individually) placed within the projection of the fixing arrangement 252 (i.e., the plate 2520 thereof) along the overlapping direction.

Advantageously, the coupling seats 2521 (and/or the locking element 2523 where provided) are substantially aligned (along the overlapping direction) with the coupling body 251 (i.e., the rigid pins).

The (fork-like frame of the) rigid constraint body 250 (with the coupling body 251 and the fixing arrangement 252) defines a short kinematic chain along the overlapping direction (i.e. the distance along the overlapping direction between the coupling body 251 and the fixing arrangement 252 is minimal and the two are joined by a rigid body—defined by the fork-like frame—which develops along this overlapping direction orthogonal to the upper platform of the support frame 21, i.e. enabling any torque or bending moment between them—i.e. on the rigid constraint body 250—to be null when they are subjected to stresses directed orthogonally to the upper platform of the support frame 21 and/or to the loading surface L of the ambulance V).

The support frame 21 further comprises at least one pair of rollers 215, preferably two pairs of rollers, of which a first front pair and a second rear pair.

Wherein the rollers of each pair of rollers 215 are placed on opposite parts of the support frame 21, for example aligned and coaxial, and are rotatably coupled to the support frame 21 (in an idle manner) about a (common) rotation axis parallel to the upper platform of the support frame 21 and orthogonal to the longitudinal axis of the support frame 21.

The rollers of each pair of rollers 215 are (slightly) facing above the upper platform of the support frame 21.

Preferably, each pair of rollers 215 is fixed to a respective fixing arrangement 252, for example aligned with the pair of coupling seats 2521, at the enlarged axial section thereof.

An accompanying shoe is provided in front of and behind each roller 215 which is coplanar with the upper surface of the support frame 21.

The support frame 21 further comprises at least one additional hook 216.

The additional hook 216 is protruding from a sidewall of the support frame 21, for example in a central zone thereof protruding above the upper surface of the support frame 21.

The additional hook 216 is defined by a “C”-shaped slot open at the rear, i.e. with a concavity facing the rear end of the support frame 21.

First Undercarriage

In a preferred embodiment, the patient transport system 10 comprises a first undercarriage 20 with semi-automatic or servo-assisted drive.

The first undercarriage 20 then comprises a pair of front legs 22 and a pair of rear legs 23 coupled inferiorly to the support frame 21 and through which the support frame 21 is supported resting on a rest plane of the first undercarriage 20 (defined by the ground and/or the loading surface L).

The pair of front legs 22, including one on the right and one on the left, are mutually integral (for example, they are rigidly connected to each other).

Preferably, the pair of front legs 22 is articulated to the support frame 21 so that their position can be varied with respect thereto.

In detail, the pair of front legs 22 is rotatably coupled to the support frame 21 (for example at a constrained end of each front leg 22) around a (single) first rotation axis R1, with the possibility of rotating between two opposing angular end stroke positions, including
a raised (closed) angular end stroke position, in which the pair of front legs 22 (i.e. the free ends of the front legs 22 of the pair of front legs 22) is proximal to the support frame (i.e. a front angle between the pair of front legs 22 and the support frame 21, i.e. its loading platform, is minimum), and
a lowered (open) angular end stroke position, in which the pair of front legs 22 (i.e. the free ends of the front legs 22 of the pair of front legs 22) is distal from the support frame 21 (i.e. a front angle between the pair of front legs 22 and the support frame 21, i.e. its loading platform, is maximum).

This front angle is, however, less than 90°, e.g. comprised between 0° and 70°. Each front leg 22 supports, at its free end, a respective front wheel holder frame 220.

The front wheel holder frame 220 is, for example, hinged to (the free end of) the respective front leg 22 around a first oscillation axis O1 parallel to the first rotation axis R1.

Each front wheel holder frame 220, in turn, supports a respective front wheel 221 for resting and rolling on the aforesaid rest plane.

Each front wheel 221 is preferably pivoting, i.e. capable of spinning (in a free or controlled and/or lockable manner) around a respective first pivot axis P1 orthogonal to the first oscillation axis O1.

In detail, each front wheel 221 is rotatably connected (for free rotations), around a revolution axis, to a support element, for example fork-like, which is in turn rotatably connected (in order to be able to perform 360° rotations), around the first pivot axis P1, to the front wheel holder frame 220.

The pair of front legs 22 and the pair of rear legs 23 are independent of each other, i.e. they are movable independently with respect to the support frame 21.

The pair of rear legs 23, one of which on the right and one on the left, are mutually integral (for example, they are rigidly connected to each other).

Preferably, the pair of rear legs 23 is articulated to the support frame so that their position can be varied with respect thereto.

In detail, the pair of rear legs 23 is rotatably coupled to the support frame 21 (e.g. at a constrained end of each rear leg 23) around a (single) second rotation axis R2 (proximal to the first rotation axis R1, e.g. parallel to and separate from it or at most also coinciding), with the possibility of rotating between two opposing angular end stroke positions, including:
a raised (or closed) angular end stroke position, in which the pair of rear legs 23 (i.e. the free ends of the rear legs 23 of the pair of rear legs 23) is proximal to the support frame (i.e. a rear angle between the pair of rear legs 23 and the support frame 21, i.e. its loading platform, is minimum), and
a lowered (open) angular end stroke position, in which the pair of rear legs 23 (i.e. the free ends of the rear legs 23 of the pair of rear legs 23) is distal from the support frame 21 (i.e. a rear angle between the pair of rear legs 23 and the support frame 21, i.e. its loading platform, is maximum).

This rear angle is, however, less than 90°, e.g. comprised between 0° and 70°. Each rear leg 23 supports, at its free end, a respective rear wheel holder frame 230.

The rear wheel holder frame 230 is, for example, hinged to (the free end of) the respective rear leg 23 around a second oscillation axis O2 parallel to the second rotation axis R2.

Each rear wheel holder frame 230, in turn, supports a respective rear wheel 231 for resting and rolling on the aforesaid rest plane.

Each rear wheel 231 is preferably pivoting, i.e. capable of spinning (in a free or controlled and/or lockable manner) around a respective second pivot axis P2 orthogonal to the second oscillation axis O2.

In detail, each rear wheel 231 is rotatably connected (for free rotations), around a revolution axis, to a support element, for example fork-like, which is in turn rotatably connected (in order to be able to perform 360° rotations), around the second pivot axis P2, to the rear wheel holder frame 230.

The pair of front legs 22 and the pair of rear legs 23 are mutually opposed.

In other words, the free ends of the front legs 22 of the pair of front legs 22 and the free ends of the rear legs 23 of the pair of rear legs 23 are proximal to each other when the pair of front legs 22 and the pair of rear legs 23 are in the lowered angular end stroke position and the free ends of the front legs 22 of the pair of front legs 22 and the free ends of the rear legs 23 of the pair of rear legs 23 are distal to each other when the pair of front legs 22 and the pair of legs rear 23 are in the raised angular end stroke position.

For example, the free ends of the front legs 22 of the pair of front legs 22 and the free ends of the rear legs 23 of the pair of rear legs 23 are arranged proximal and/or at, respectively, the front end and the rear end of the support frame 21, when the pair of front legs 22 and the pair of rear legs 23 are in the raised angular end stroke position.

The first rotation axis R1 and the second rotation axis R2 are close to each other (coinciding at most) and proximal to a median plane orthogonal to the (loading platform of the) support frame 21 parallel to them.

Still, the support frame 21 and/or the pair of front legs 22 and/or the pair of rear legs 23 may also provide one or more auxiliary rest wheels projecting below the surface of the legs 22 and 23 and having a rotation axis parallel to the first rotation axis R1 and to the second rotation axis R2 and a rest directrix arranged at the same height as the rest directrix of the front wheels 221 and of the rear wheels 231, when they are in the raised angular end stroke position.

The first undercarriage 20 comprises an actuation arrangement configured to independently actuate the handling of the pair of front legs 22 and of the pair of rear legs 23, for example between the respective raised end stroke position and the respective lowered end stroke position.

The actuation arrangement comprises a first front actuator 225, which moves the pair of front legs 22 and which interconnects the support frame 21 and the pair of front legs 22.

The first front actuator 225 is, for example, a linear actuator, e.g. of the hydraulic type driven by an electric motor.

The first front actuator 225 has, for example, a cylinder, one end of which is hinged to the support frame 21, e.g. to an ear resulting from or arranged at the lower surface thereof, and a stem, one end of which is hinged to the pair of front legs 22, e.g. to a crossbar joining them.

The hinge axes of the stem and of the cylinder are parallel (and eccentric) to the first rotation axis R1.

The actuation arrangement further comprises a first rear actuator 235, which moves the pair of rear legs 23 and which interconnects the support frame 21 and the pair of rear legs 23.

The first rear actuator 235 is, for example, a linear actuator, e.g. of the hydraulic type driven by an electric motor.

The first rear actuator 235 has, for example, a cylinder, one end of which is hinged to the support frame 21, e.g. to an ear resulting from or arranged at the lower surface thereof, and a stem, one end of which is hinged to the pair of rear legs 23, e.g. to a crossbar joining them.

The hinge axes of the stem and cylinder are parallel (and eccentric) to the second rotation axis R2.

The first undercarriage 20 further comprises a handling arrangement configured to independently actuate the handling of each of the front wheel holder frame 220 around the first oscillation axis O1 and of each rear wheel holder frame 230 around the second oscillation axis O2 (to vary the inclination with respect to the respective leg).

The handling arrangement comprises, for each front leg 22 of the pair of front legs 22 a respective second front actuator 226.

Each second front actuator 226 moves a respective front wheel holder frame 220 and interconnects the respective front leg 22 of the pair of front legs 22 and the respective front wheel holder frame 220.

Each second front actuator 226 is for example a linear actuator, for example of the electric type provided with an electrically controlled brake.

Each second front actuator 226 has, for example, a cylinder, one end of which is fixed or hinged to the respective front leg 22 (e.g., internally therein), and a stem, one end of which is hinged to the respective front wheel holder frame 220, for example, at a connection ear thereof.

The hinge axis of the stem is parallel (and eccentric) to the first oscillation axis O1.

In addition, the handling arrangement comprises, for each rear leg 23 of the pair of rear legs 23, a respective second rear actuator 236.

Each second rear actuator 236 moves a respective rear wheel holder frame 230 and interconnects the respective rear leg 23 of the pair of rear legs 23 and the respective rear wheel holder frame 230.

Each second rear actuator 236 is for example a linear actuator, for example of the electric type provided with an electrically controlled brake.

Each second rear actuator 236 has, for example, a cylinder, one end of which is fixed or hinged to the respective rear leg 23 (e.g., internally therein), and a stem, one end of which is hinged to the respective rear wheel holder frame 230, for example, at a connection ear thereof.

The hinge axis of the stem is parallel (and eccentric) to the second oscillation axis O2.

The first undercarriage 20 comprises a front coupling body 26 connected to the front end of the support frame 21, for example facing anteriorly and/or inferiorly therefrom (and frontally the front fixing arrangement 25).

The coupling body 26 comprises a coupling head 260 (facing anteriorly and/or inferiorly to the support frame 21), which is for example supported by a small support frame 261 rigidly fixed to the support frame 21.

The small support frame 261 is of the box type with the coupling head 260 protruding from the front free end.

Preferably, the coupling head 260 is defined/constituted by a spherical or hemispherical (or at most truncated conical/pyramidal) body.

The coupling body 26, in particular the coupling head 260, is arranged on the longitudinal median plane orthogonal to the rest platform (i.e. vertical) of the support frame 21.

Preferably, the coupling head 260 is centred on said longitudinal median plane, i.e. it has a centre that belongs to said longitudinal median plane.

Advantageously, the coupling head 260 is associated with the small support frame 261 and, therefore, with the support frame 21 in a movable manner (free to move, not actuated).

In particular, the coupling head 260 is associated with the small support frame 261 and, therefore, with the support frame 21 with the possibility of movement with respect to at least a first degree of translational (and/or roto-translational) freedom substantially parallel to the (rest platform of the) support frame 21 and, preferably, directed along the longitudinal axis of the support frame 21, between two horizontal (mechanical) end stroke positions, including a front end stroke, wherein the coupling head 260 is distal from the support frame 21, and a rear end stroke, wherein the coupling head 260 is proximal to the support frame 21.

Furthermore, the coupling head 260 is associated with the small support frame 261 and, therefore, with the support frame 21 with the possibility of movement with respect to at least a second degree of translational (and/or roto-translational) freedom substantially orthogonal to the (rest platform of the) support frame 21, between two vertical (mechanical) end stroke positions, including a lower end stroke, wherein the coupling head 260 is distal from the support frame 21, and an upper end stroke, wherein the coupling head 260 is proximal to the support frame 21.

In particular, the coupling head 260 is connected to the small support frame 261 by means of an articulation, which is for example defined by an articulated kinematic mechanism 262 (such as an articulated quadrilateral), which allows the translation of the coupling head 260 with respect to the aforesaid first degree of translational freedom and to the second degree of translational freedom.

The articulated kinematic mechanism 262 is defined by a plurality of levers hinged to each other (and interconnected with the small support frame 261 defining one of said levers) by means of respective articulation axes, wherein the articulation axes of the articulated kinematic mechanism are all parallel to each other and parallel to the first rotation axis R1 and to the second rotation axis R2.

Advantageously, the coupling head 260 is movable from the front end stroke to the rear end stroke in contrast to first elastic means, for example defined by a first spring 263, for example helical.

In practice, the first spring 263 is configured so as to define the front end stroke position as a stable equilibrium position for the coupling head 260 (and the rear end stroke position as an unstable equilibrium position for the coupling head 260).

The first spring 263 is connected to the articulated kinematic mechanism, e.g. interconnected between two levers thereof.

In addition, the coupling head 260 is movable from the lower end stroke to the upper end stroke in contrast to second elastic means, e.g. defined by a second spring, e.g. helical.

In practice, the second spring is configured so as to define the lower end stroke position as a stable equilibrium position for the coupling head 260 (and the upper end stroke position as an unstable equilibrium position for the coupling head 260).

The second spring is connected to the articulated kinematic mechanism, e.g. interconnected between two levers thereof.

Preferably, the second spring coincides with the first spring 263.

The first undercarriage 20, i.e., the coupling body 26, further comprises a release arrangement arranged at the front end of the support frame 21, i.e., the small support frame 261, and configured to operate a release of the coupling body 26, as will be better described below.

The release arrangement comprises, for example, a first pin 265, slidingly associated with the small support frame 261 and, therefore, with the support frame 21 along a sliding direction parallel to the (rest platform of the) support frame 21 and directed along the longitudinal axis of the support frame 21, between two horizontal end stroke positions, including an extracted position, wherein the first pin 265 protrudes at least partially externally to the small support frame 261, preferably beyond at least an axial portion of the coupling head 260 (at least when this is in the rear end stroke position), and distal from the support frame 21, and a retracted position, wherein, for example, the first pin 265 retracts internally to the small support frame 261 (receding with respect to the coupling head 260).

For example, the first pin 265 is actuated between its extracted position and its retracted position by a first actuator means, defined for example by a first servomotor 266 fixed to the small support frame 261, for example internally thereto.

The release arrangement comprises, for example, a second pin 267, slidingly associated with the small support frame 261 and, therefore, with the support frame 21 along a sliding direction orthogonal to the (rest platform of the) support frame 21, between two vertical end stroke positions, including an extracted position, wherein the second pin 267 at least partially protrudes externally to the small support frame 261 (inferiorly thereto), preferably beyond at least a radial portion of the coupling head 260 (at least when this is in the upper end stroke position), and distal from the support frame 21, and a retracted position, wherein for example the second pin 267 retracts internally to the small support frame 261 (receding with respect to the coupling head 260).

For example, the second pin 267 is actuated between its extracted position and its retracted position by a second actuator means, defined for example by a second servomotor 268 fixed to the small support frame 261, for example internally thereto.

The first undercarriage 20 comprises a sensor arrangement.

The sensor arrangement, for example, comprises at least a first front angle sensor S1 associated with the pair of front legs 22 (and/or with the first front actuator 225), wherein the first front angle sensor is configured to detect an angular position of the pair of front legs 22 with respect to the support frame 21.

The sensor arrangement, for example, comprises at least a first rear angle sensor S2 associated with the pair of rear legs 23 (and/or with the first rear actuator 235), wherein the first rear angle sensor S2 is configured to detect an angular position of the pair of rear legs 23 with respect to the support frame 21.

The sensor arrangement, for example, may comprise at least a second front angle sensor S3 associated with at least one front wheel holder frame 220, for example one for each front wheel holder frame 220, wherein each second front angle sensor S3, is configured to detect an angular position of the respective front wheel holder frame 220 with respect to the respective front leg 22.

The sensor arrangement, for example, may comprise at least a second rear angle sensor S4 associated with at least one rear wheel holder frame 230, for example one for each rear wheel holder frame 230, wherein the second rear angle sensor S4 is configured to detect an angular position of the respective rear wheel holder frame 230 with respect to the respective rear leg 23.

The sensor arrangement, for example, comprises at least one front absolute linear potentiometer S5 associated with at least one front wheel holder frame 220, for example one for each front wheel holder frame 220, wherein each front absolute linear potentiometer S5 is configured to detect an absolute angular position of the respective front wheel holder frame 220.

The sensor arrangement, for example, comprises at least one rear absolute linear potentiometer S6 associated with at least one rear wheel holder frame 230, for example one for each rear wheel holder frame 230, wherein each rear absolute linear potentiometer S6 is configured to detect an absolute angular position of the respective rear wheel holder frame 230.

The sensor arrangement, for example, comprises a first distance sensor S7 (e.g. of the laser, on/off type) fixed to the support frame 21, e.g. to the lower surface thereof (preferably at the transverse median plane orthogonal to the longitudinal axis of the support frame), facing downwards, wherein the first distance sensor S7 is configured to detect a distance between the support frame 21 (i.e. its lowest lower surface) and the underlying rest plane.

The sensor arrangement, for example, comprises a second distance sensor S8 (e.g. of the laser, on/off type) fixed to the support frame, e.g., near the front end thereof, preferably at the small support frame 261, e.g. at the lower surface thereof, facing downwards, wherein the second distance sensor S8 is configured to detect a distance between the support frame 21, i.e. the small support frame 261 (i.e. its lowest lower surface) and an underlying abutment surface.

The sensor arrangement, for example, comprises a first proximity sensor S9 (e.g. of the magnetic type) fixed to the support frame, for example, near the front end thereof, preferably at the small support frame 261, facing anteriorly, wherein the first proximity sensor S9 is configured to detect a proximity between the support frame 21, i.e. the small support frame 261, and a front abutment surface.

The sensor arrangement, for example, comprises a first limit switch sensor S10, for example fixed to the small support frame 261, which is configured to detect when the coupling body 26, i.e. the coupling head 260, is in its rear end stroke position.

For example, the first limit switch sensor S10 is of the type of a contact (mechanical) switch (of the on/off type).

The sensor arrangement, for example, comprises a second limit switch sensor S11, for example fixed to the small support frame 261, which is configured to detect when the coupling body 26, i.e. the coupling head 260, is in its upper end stroke position.

For example, the second limit switch sensor S11 is of the type of a contact (mechanical) switch (of the on/off type).

The sensor arrangement, for example, comprises a third distance sensor S12 (e.g. of laser type), arranged on the coupling body 26, for example integral with at least one between the small support frame 261 and the coupling head 260.

The sensor arrangement, for example, comprises a second proximity sensor S13 (e.g., a magnetic reed) arranged on/in proximity to a (single pin of) coupling portion 251, for example on each of the front and rear coupling bodies 251 or preferably only at the front coupling bodies 251.

The sensor arrangement, for example, comprises a front pressure sensor S14 associated with the (hydraulic circuit of) first front actuator 225, which is for example configured to detect a pressure value of the actuating fluid of the first front actuator 225.

The sensor arrangement, for example, comprises a rear pressure sensor S15 associated with the (hydraulic circuit of) first rear actuator 235, which is for example configured to detect a pressure value of the actuating fluid of the first rear actuator 235.

The sensor arrangement, for example, comprises an inclinometer and/or a gyroscope and/or an accelerometer S16 associated with the support frame 21, e.g. at/in proximity to the rear end thereof, as will be better described below.

Preferably, the sensor arrangement comprises at least one sensor S17, preferably a pair, configured to detect proper locking of the locking element 2523.

Still, the sensor arrangement comprises a reader S18 (e.g. a radio reader or an optical reader), e.g. arranged at the upper surface of the support frame 21, e.g., facing upward.

The first undercarriage 20 further comprises an on-board power supply system. For example, the first undercarriage 20 comprises at least one battery (or battery pack) fixed to the support frame 21, for example in a rechargeable and/or removable and/or replaceable manner.

The power supply system is configured to supply power to the actuation arrangement, and/or the handling arrangement and/or the sensor arrangement and/or the release arrangement and/or a control module (described hereinbelow). The first undercarriage 20 further comprises a control module 27, which is, for example, arranged at/in proximity to the rear end of the support frame 21.

The control module 27 is, generally, configured to receive commands as input from the operator and provide indications as output to be made available to the operator and/or other command signals to be made available to the system 10 and/or to the first undercarriage 20.

The control module 27, for example, may comprise one or more commands 270 which can be actuated by the operator.

For example, the commands 270 can be fixed to the handle bar 211 and/or near it at the rear end of the support frame 21.

The operator can use the commands 270 in the loading and unloading of the first undercarriage 20 to control and/or command the movement of the pair of front legs 22 and of the pair of rear legs 23 and other.

The commands 270 may further comprise one or more lifting buttons (“+”) which can be actuated to raise the first undercarriage 20 and one or more lowering buttons (“−”) which can be actuated to lower the first undercarriage 20.

Each of the lifting buttons and the lowering buttons may generate signals that actuate the pair of front legs 22, the pair of rear legs 23 or both to perform functions of the first undercarriage 20, which provide for the pair of front legs 22, the pair of rear legs 23 or both to be lowered or raised.

In some embodiments, each of the lifting buttons and of the lowering buttons may be analogue (i.e., pressing and/or moving the button may be proportional to a parameter of the control signal).

The actuation speed of the pair of front legs 22, of the pair of rear legs 23 or both can be proportional to the control signal parameter.

The control module 27 may comprise a visual display component or graphical user interface 271 configured to make (visual, tactile, auditory or otherwise) information available to the operator.

For example, the user interface 271 is fixed to the rear end of the support frame 21.

The user interface 271 may comprise any device capable of emitting an image such as, for example, a liquid crystal display, a touch screen or the like.

One or more lifting buttons and lowering buttons can be defined as integral to the graphical interface.

In addition, the inclinometer and/or gyroscope and/or accelerometer S16 can be defined integrated into the graphical interface.

The first undercarriage 20, i.e. the control module 27 thereof, further comprises an electronic control unit 272.

The electronic control unit 272 may be any device/processor capable of executing machine-readable instructions such as, for example, a controller, an integrated circuit, a microchip or the like.

As used herein, the term “communicatively coupled” means that the components are capable of exchanging data signals with each other such as, for example, electrical signals via conductive medium, electromagnetic signals via air, optical signals via optical waveguides and the like.

The electronic control unit 272 may be provided with or connected to one or more memory modules, which may be any device capable of storing data and/or instructions and/or software programmes that can be read and implemented by the electronic control unit 272.

The electronic control unit 272 is operationally connected to the actuation arrangement, and/or the handling arrangement and/or the sensor arrangement and/or the control module 27 and/or the power supply system and/or the release arrangement.

For example, the control module 27 (i.e. the electronic control unit 272) is operationally connected to the release piston 2510, for controlling the operation thereof.

### Second Undercarriage

In a further embodiment, the patient transport system 10 comprises, alternatively or in addition to what is described above, a second (predominantly manually operated) and/or self-loading undercarriage 20.

The support frame 21 (of the second undercarriage 20) is also rigid and, for example, is a tubular frame, i.e. formed by a latticework of tubes or bars (with circular or quadrangular section) joined together, for example by welding.

The second undercarriage 20 comprises, for example, a pair of front legs 22 and a pair of rear legs 23 rotatably connected to the main frame 21, for example at a respective hinge point (fixed or movable with respect to the support frame 21 and/or common for both legs or separated from each other).

The front legs 22 have, at their ends opposite to the hinge one, front wheels 221.

In addition, the rear legs 23 have, at their ends opposite to the hinge one, rear wheels 231.

Preferably, at the rear end of the support frame 21 there is the handle bar 211, for example formed by a handle, which allows the second undercarriage 20 to be grasped in order to push it during loading or to pull it for the opposite action of unloading or otherwise manoeuvre it.

In preferred embodiments, the second undercarriage 20 may further be provided with a loading portion, configured to be received resting on the loading plane L. In some embodiments, the loading portion is defined by one or more wheels mounted on a bar fixed to the support frame 21.

The front legs 22 and the rear legs 23 can be rotated, e.g. individually or synchronously, in such a way that they can be arranged
in a stretched position, wherein they are intended to support the support frame 21 at a first (maximum) distance from the ground S, and
in a retracted position, wherein they are intended to support the support frame 21 at a second (minimum) distance from the ground S, which is less than the first distance.

When (both) legs 22, 23 are in the retracted position they are arranged adjacent to the main frame 21.

Each of the legs 22 and 23 may have an automatic locking/unlocking mechanism (not illustrated) configured to lock the wheels at least in the extracted position.

For example, if the second undercarriage 20 is of the self-loading type, each leg 22 may be configured to switch from the extended position to the retracted position by first unlocking the locking/unlocking mechanism, following a (forced) contact with a part of the ambulance V (i.e. with the rear end of the loading plane L) thereof (along a loading stroke of the second undercarriage 20).

The patient transport system 10 comprises a fleet (or plurality) of undercarriages 20, wherein the fleet of undercarriages 20 may be variously configured according to the needs, for example defined by at least a first undercarriage 20 and at least a second undercarriage 20 (such as a first undercarriage 20 and a plurality of second undercarriages 20, a second undercarriage 20 and a plurality of first undercarriages 20 or a plurality of first undercarriages 20 and a plurality of second undercarriages 20) or a plurality of first undercarriages 20 or a plurality of second undercarriages 20.

The transport system 10, as mentioned, comprises, at least one additional device 30, which is configured to support restingly and accommodate a patient. For example, the additional device 30 is sized to suit the nature of the subject to be transported, e.g. by having sufficient length and width to accommodate on it at least one patient it is intended to support.

The additional device 30 is configured, moreover, to be mounted (and supported), in a releasable manner, on the undercarriage 20, for example any one of the above described undercarriages 20 (be it a first undercarriage 20 or a second undercarriage 20).

The additional device 30 comprises a load-bearing structure 31.

The load-bearing structure 31 has, for example, a predominant longitudinal development (along a longitudinal axis) and comprises two opposing axial ends, including a front end and a rear end.

The front end is to be understood herein as the “loading end” or “head side end”. The rear end is, on the other hand, to be understood as the “control end” or “feet side end”.

The load-bearing structure 31 is rigid, rigid being understood to mean capable of resisting (without apparent deformations when it is subjected to the loads that it is intended—in its own way—to support during use).

The load-bearing structure 31, for example, is defined by two parallel (and spaced apart), e.g. metallic, side members 310, joined together by one or more crossbars 311 (parallel to each other and, for example, orthogonal to the side members 310).

Each crossbar 311 is joined, for example rigidly fixed (by welding or threaded members or otherwise), at its opposite ends to a respective side member 310. Preferably, handle bars 312 (or handles) for manually gripping the additional device 30 are defined at the opposite ends of the side members 310.

One or both of the side members 310 may be rigidly fixed (by welding or threaded members or otherwise) to one or more support brackets 313, for example facing inwards of the two side members 310 (and cantilevered).

In the example, the load-bearing structure 31 has at least two main crossbars 311, including a feet-side crossbar and a head-side crossbar.

The main crossbars 311 are, by way of example only, spaced from each other by a distance substantially equal to 2 times (more or less) the distance between each main crossbar 311 and the axial end of the side members 310 (i.e., the axial end of the handle bars 312).

For example, the load-bearing structure 31 has an upper face and an opposing lower face.

The load-bearing structure 31 might have one or more rest wheels 314, for example 4 in number, which, for example, protrude below the lower face.

For example, the wheels 314 are rotatably coupled to the side members 310.

The additional device 30 comprises a fixing block 315, which is configured to engage, in a detachable manner, with the fixing assembly 25 of the undercarriage 20, defining a rigid, releasable constraint therewith.

The locking arrangement 315 is rigidly fixed to the load-bearing structure 31 of the additional device 30, for example by a threaded and/or welded or piece-defined connection therewith or other stable fixing technique.

The locking arrangement 315 is non-deformable (to traction, bending and twisting) to the usual mechanical stresses to which it is subjected or for which it is designed and studied, in operation.

The locking arrangement 315, for example, is fixed to the load-bearing structure 31, for example below it, so as to protrude below it.

The locking arrangement 315 comprises at least one coupling pin 3150, which has an upper axial end rigidly fixed to the load-bearing structure 31, for example to one of the crossbars 311 thereof, and an opposing free lower axial end.

The coupling pin 3150 comprises a basic stem terminating in the upper axial end at the free end of which a mushroom head (enlarged) is defined which defines the free lower axial end of the coupling pin 3150.

For example, the locking arrangement 315 comprises at least one pair of coupling pins 3150, for example flanked together along a flanking direction parallel to the longitudinal axis of the crossbar 311 supporting them.

Preferably, the fixing arrangement 315 comprises two pairs of coupling pins 3150, including one pair of front coupling pins (head side) and one pair of rear coupling pins (feet side).

Each pair of coupling pins 3150 is preferably fixed to a respective main crossbar 311.

Each coupling pin 3150 is configured to be coupled (snap) into a respective coupling seat 2521 of the fixing arrangement 252 of the undercarriage 20.

In particular, each coupling pin 3150 is configured to enter (axially/vertically) within a respective access slot 2522, at the enlarged axial section thereof.

In addition, each coupling pin 3150 is configured to slide (anteriorly/horizontally) parallel to the upper platform of the support frame 21 from the enlarged axial section to the tapered axial section to be locked therein by the locking element 2523 (where provided).

Each main crossbar 311 could comprise a pair of rest shoes configured to rest on the rollers 215 and assist the sliding of the coupling pin 3150 from the enlarged axial section to the tapered axial section of the access slot 2522.

The load-bearing structure 31 further comprises at least one additional pin 316. The additional pin 316 protrudes inferiorly from a lateral sidewall of the load-bearing structure 31 (i.e. the sidewall which is intended to be placed at the sidewall of the load-bearing frame 21 of the undercarriage 20 provided with the additional hook 26).

The additional pin 316 has a longitudinal axis parallel to the longitudinal axis of the crossbars 311.

The additional pin 316 of the additional device 30 is configured to enter the additional hook 216 of the undercarriage 20 during the coupling stroke of the coupling pins 3150 (from the enlarged axial section to the tapered axial section) in the access slots 2522.

Advantageously, the additional device 30 comprises safety belts (not illustrated as they are of a known type), which define anchorages (or anchorage points) for the patient placed on the additional device 30.

The seat belts are rigidly fixed (in a known manner) to the load-bearing structure 31 of the additional device 30, for example at one or both of the main crossbars 311 (to which the locking arrangement 315 is fixed).

The additional device 30 further comprises a support device 32, which is configured to define a (direct) rest surface for the patient.

The support device 32 is rigidly connected to the (upper face of) the load-bearing structure 31.

For example, the support device 32 is fixed to the load-bearing structure 31 by welding or by threaded connections or otherwise.

Advantageously, the support device 32 is stably mounted on the load-bearing structure 31, for example on the side members 310 and/or on the crossbars 311 and/or on the support brackets 313 thereof (by means of a multiplicity of anchorage points).

The support device 32 has, for example, a predominant longitudinal development (along a longitudinal axis), preferably parallel to the longitudinal development of the load-bearing structure 31, and comprises two opposing axial ends, including a front end and a rear end.

The support device 32 may longitudinally occupy the entire length of the load-bearing structure 31 or occupy only a longitudinal portion thereof.

The transport system 10 comprises, for example, a plurality of additional devices 30 differing from each other on the basis of a functional type thereof, i.e. differing on the basis of the specific use for which they are intended and/or for the patient for which they are designated and designed (declared).

For example, the various additional devices 30 differ from each other in the structure, shape and/or size of the support device 32 thereof.

### Additional Device According to a First Functional Type

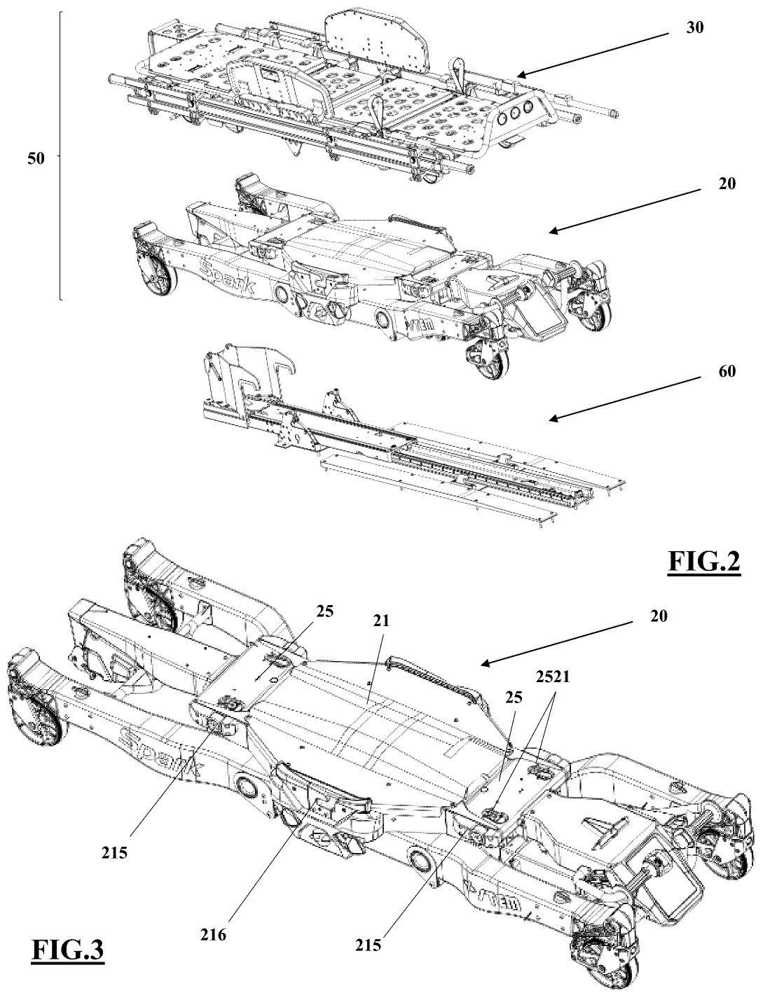

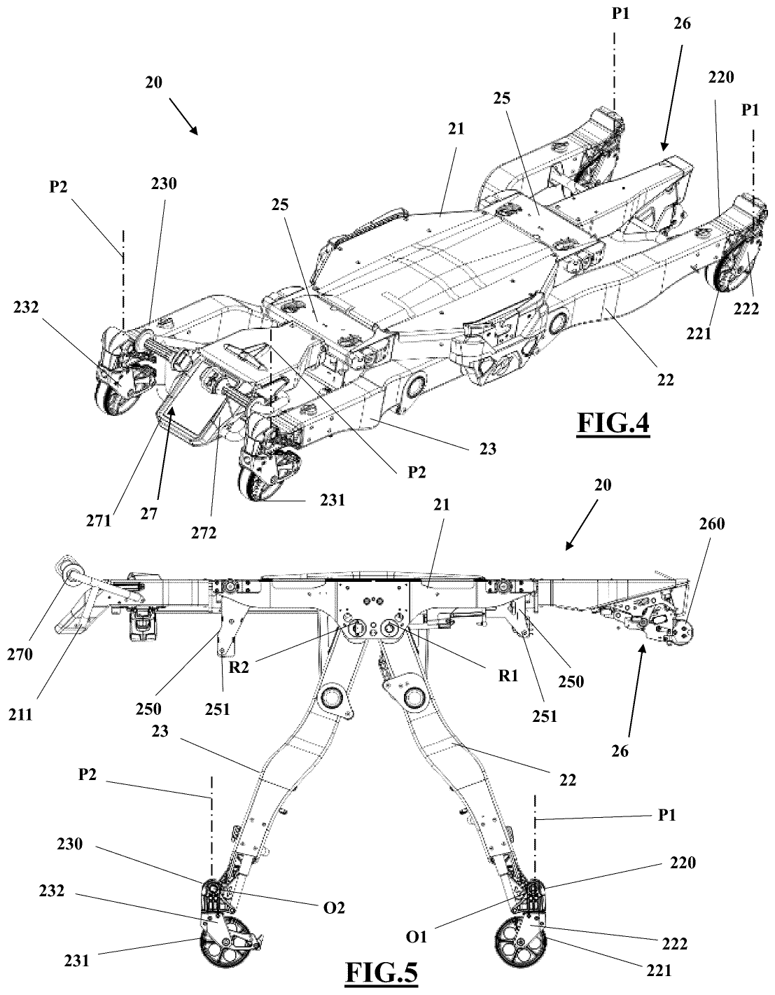

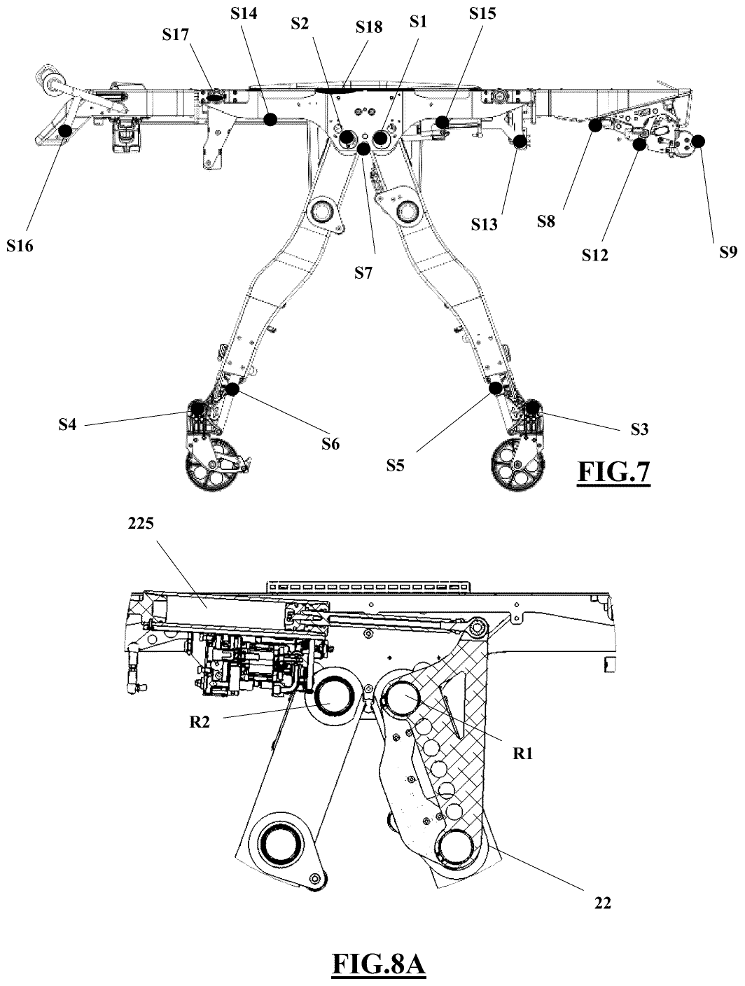

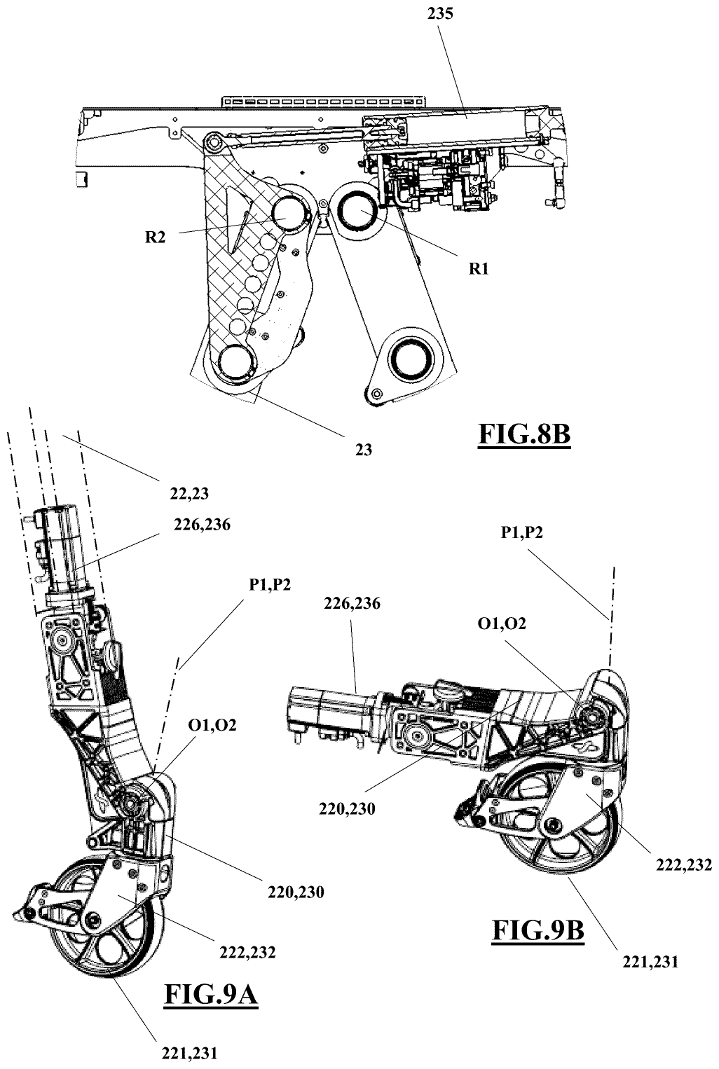

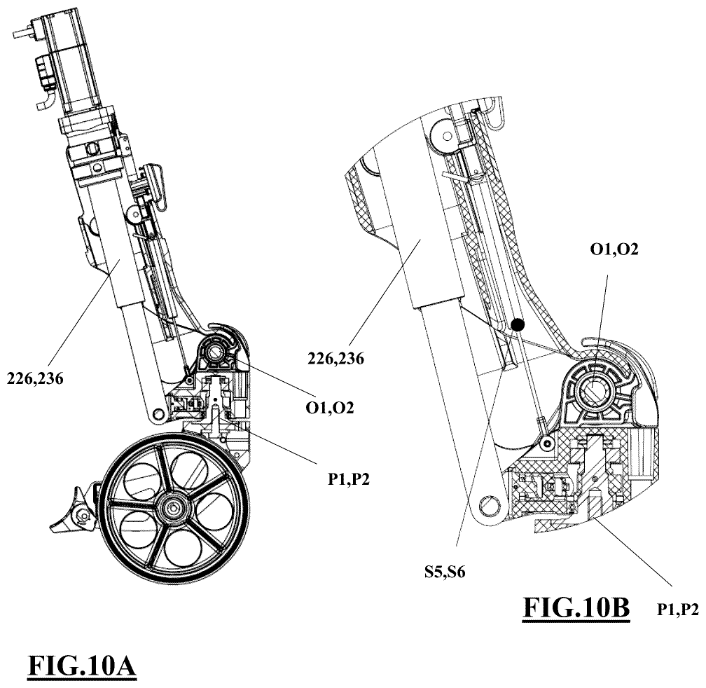

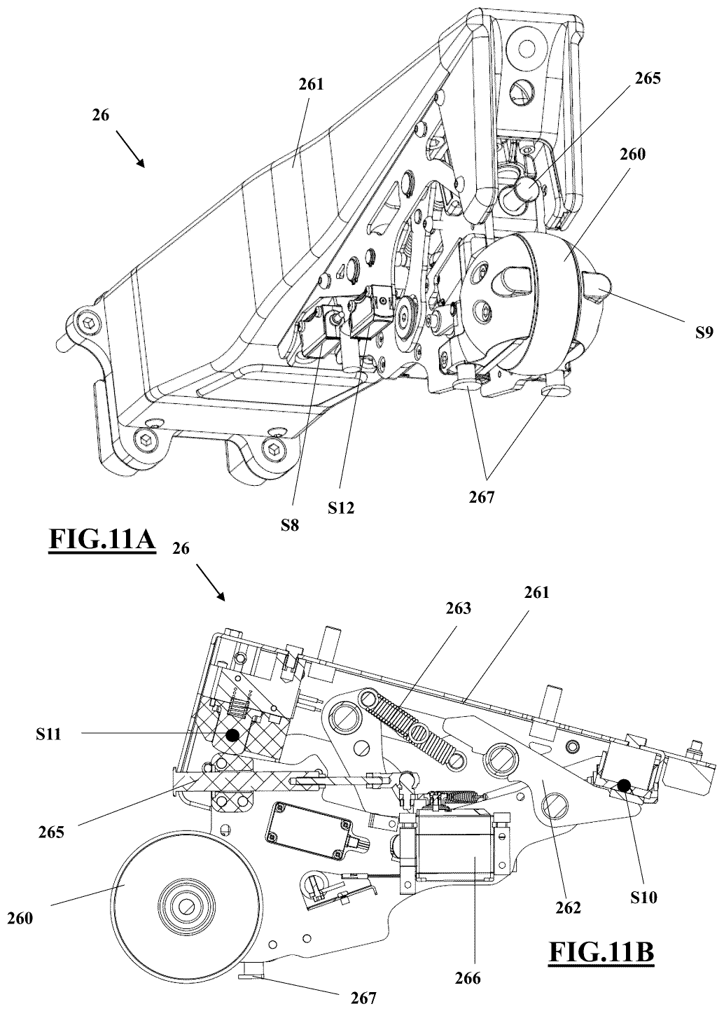

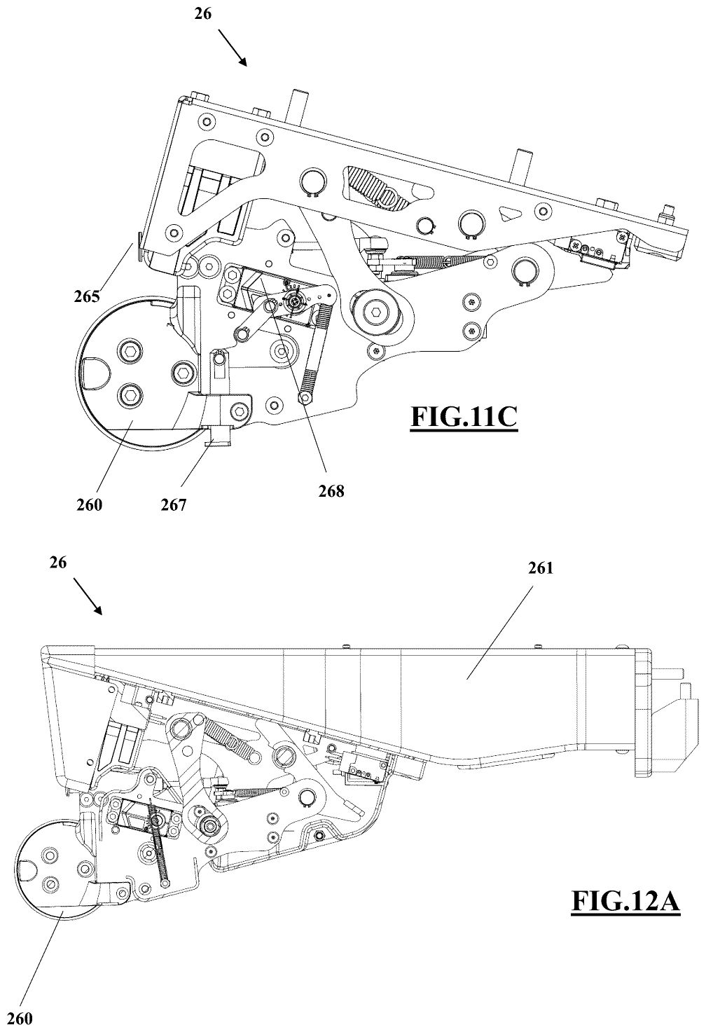

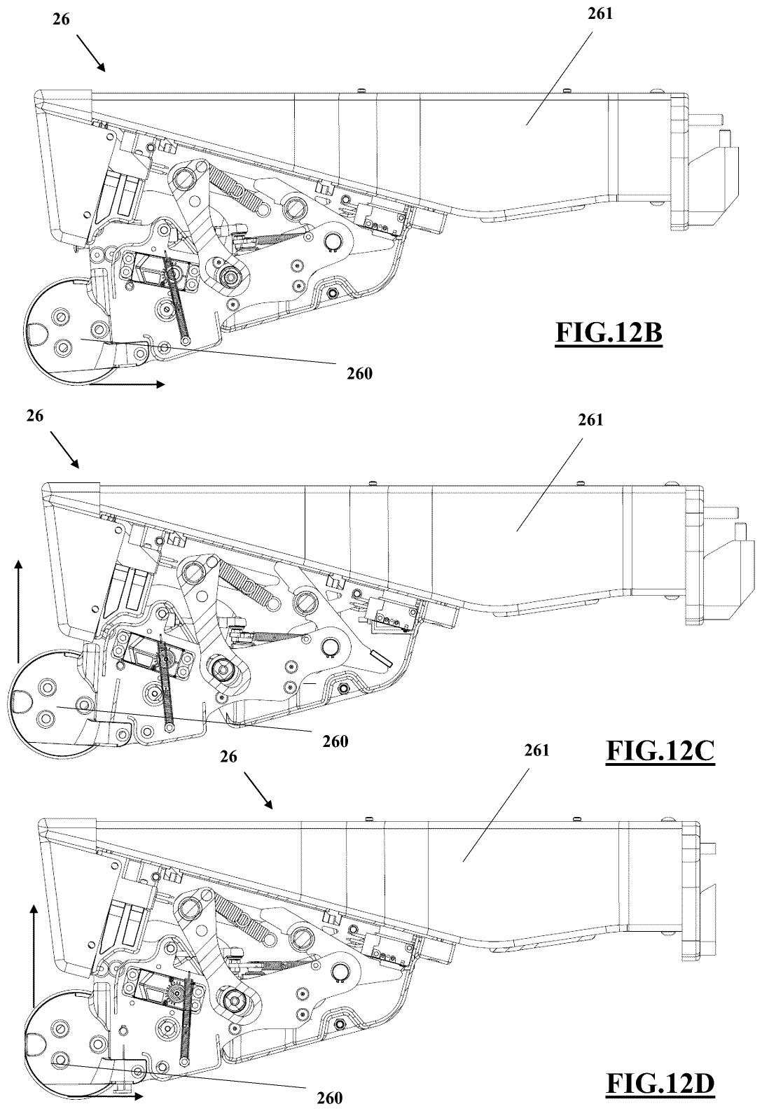

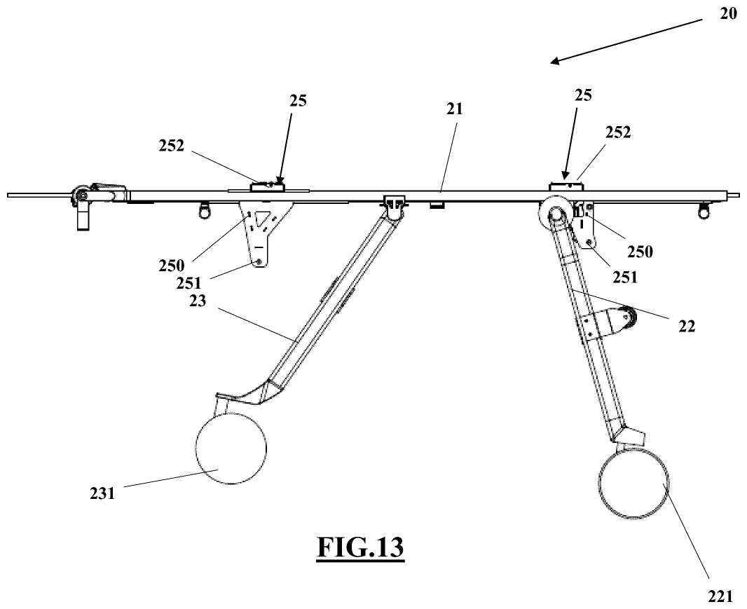

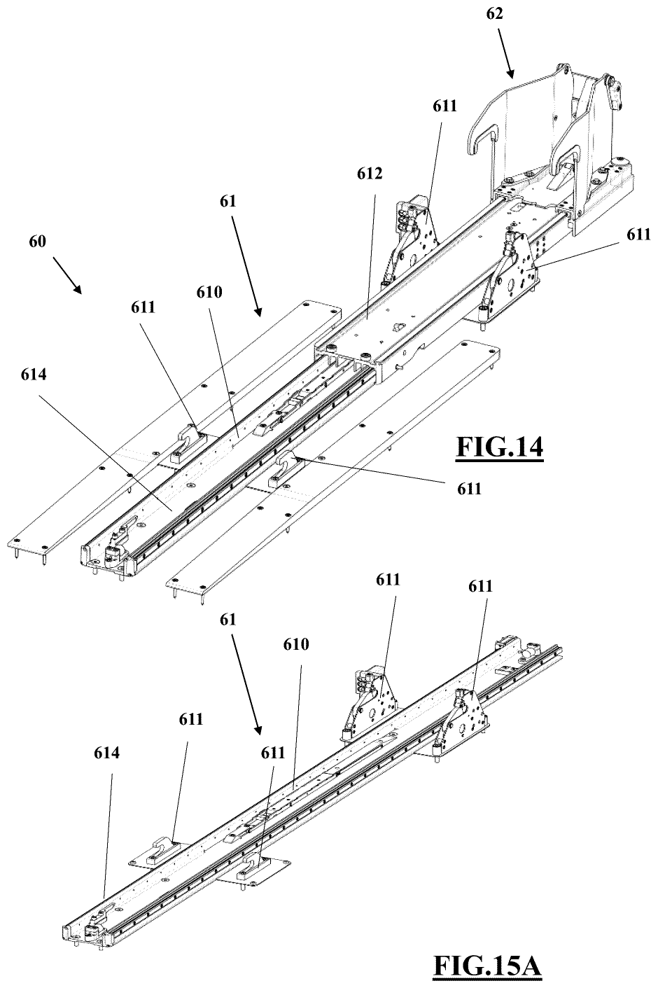

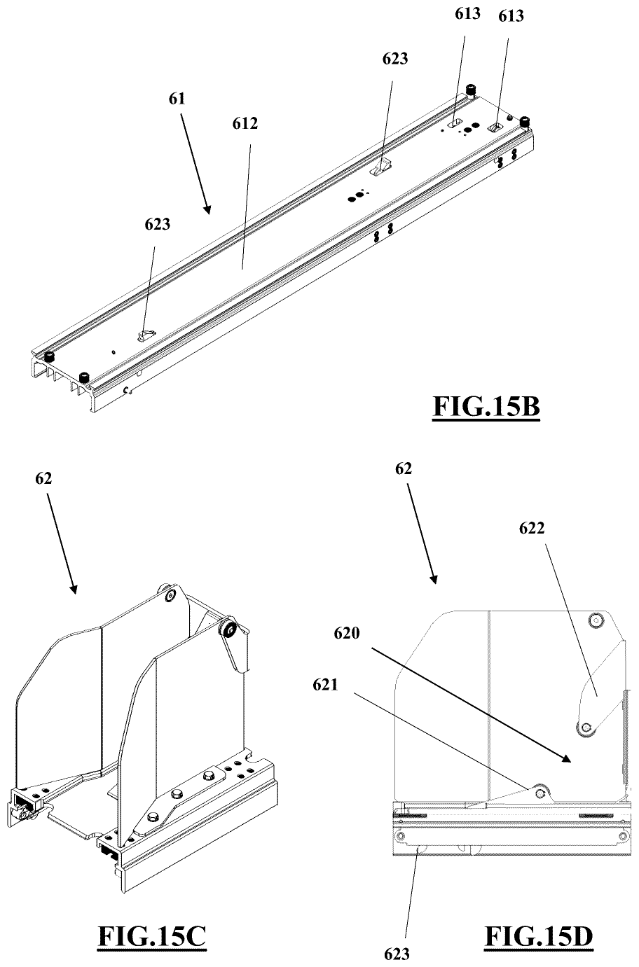

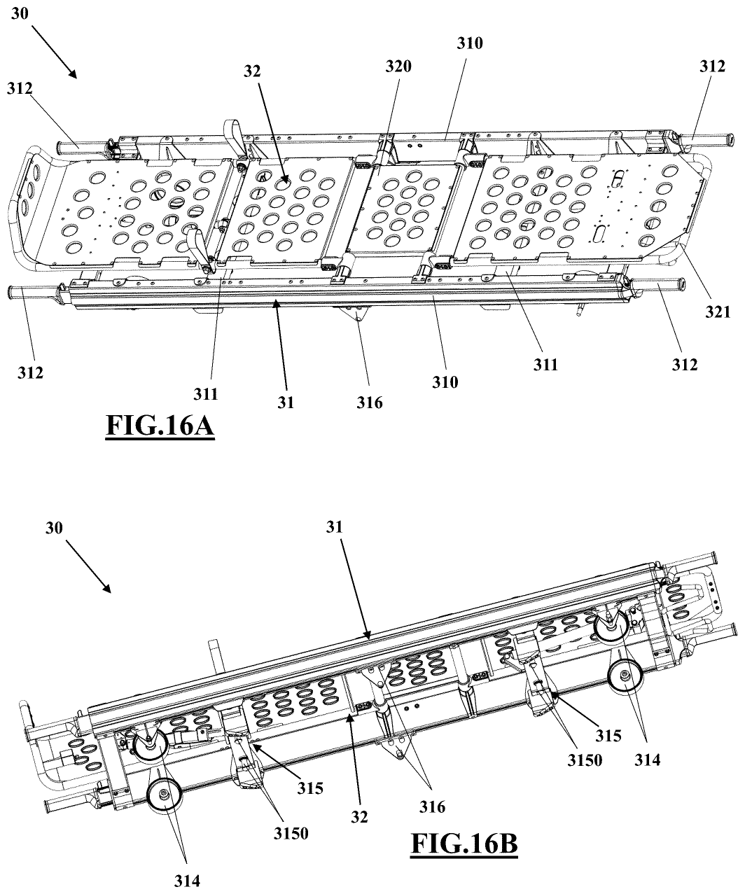

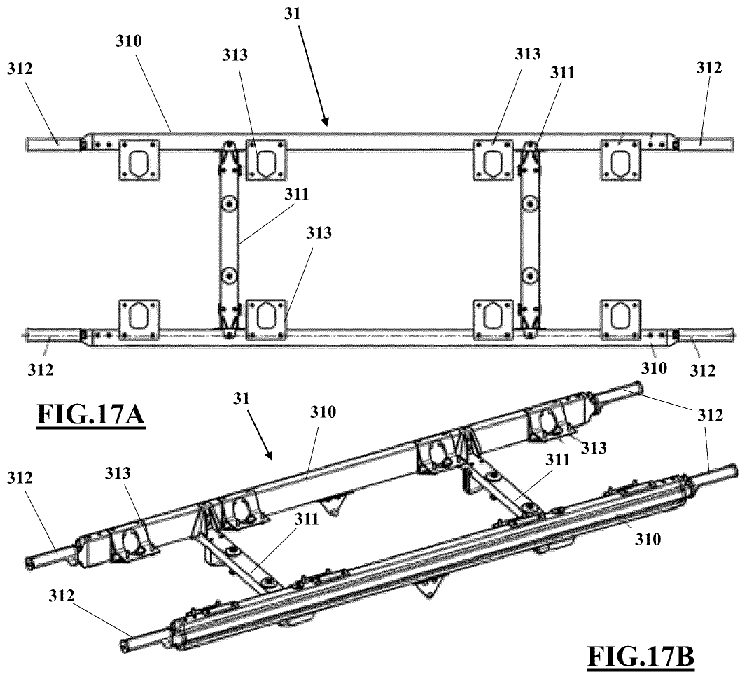

A first type of additional device 30 consists of a stretcher (or gurney), as shown in FIGS. 2,16A,16B and 28.

The first type of additional devices 30 is studied and designed, for example, for transporting patients, preferably in a lying position, for example in circumstances of intensive care (ICU) or emergency therapy.

In such a case, the support device 32 comprises (or consists of) a rest platform 320, for example perforated, supported by a perimeter small tubular frame 321 (stably mounted on the load-bearing structure 31 described above).

The rest platform 320, e.g. formed by several plates placed side by side along the longitudinal axis of the support device 32 or monolithic, is e.g. rigid (preferably but not in a limiting manner coated on the top with a soft/resilient layer) or flexible. The rest platform 320 might, in certain applications, be foldable, for example to support the patient in a semi-recumbent or sitting position.

### Additional Device According to a Second Functional Type

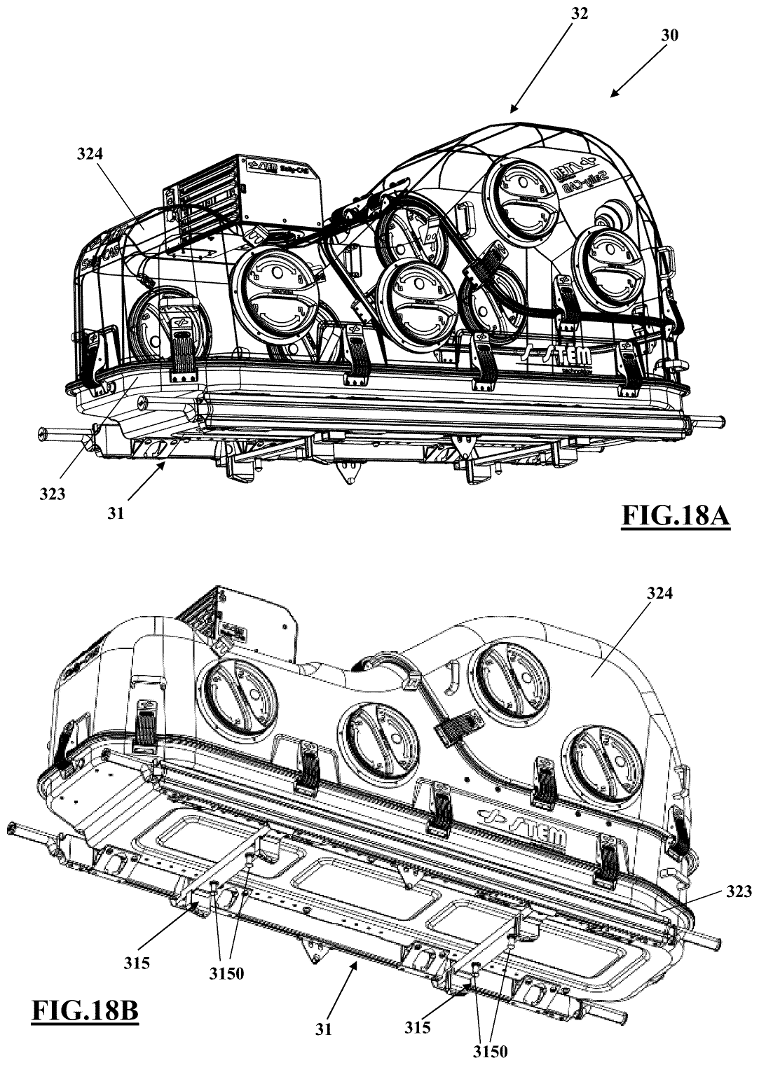

A second type of additional devices 30 is formed by a biocontainment cabin, as shown in FIGS. 18A and 18B.

The second type of additional devices 30 is studied and designed, for example, for transporting patients, preferably in a lying or sitting position, for example in circumstances of intensive care (ICU) or emergency therapy, so as to be able to isolate the transported patient from the surrounding environment (and protect the patient and/or the personnel responsible for transporting him).

In such a case, the support device 32 comprises (or consists of) a rest platform 320, e.g. perforated, supported by a perimeter lower tank 323 (stably mounted on the load-bearing structure 31) and closed at the top by at least one upper shell 324 that is closed (hermetically) on the lower tank.

The rest platform 320, e.g. formed by several plates placed side by side along the longitudinal axis of the support device 32 or monolithic, is e.g. rigid (preferably but not in a limiting manner coated on the top with a soft/resilient layer) or flexible.

The rest platform 320 is preferably foldable, e.g. to support the patient in a semi-recumbent or sitting position.

The shell 324 is for example made of rigid material.

The shell 324 is preferably made of an optically transparent material (e.g. plastic material).

The shell 324 has (quick) hooks for the removable coupling to the lower tank 323.

In addition, the shell 324 might have one or more removable portions, e.g. at the head end, to allow access to the patient (e.g. to perform resuscitation or cleaning operations or otherwise).

Still, the shell 324 might have one or more portholes that can be opened and closed (tightly) by respective (circular) hatches, e.g. provided with single-patient gloves.

Still, the support device 32 according to this second functional type of additional devices 30 comprises a ventilation system, for example battery-powered (and provided with filtering systems for the incoming air and the outgoing exhaled air), and possibly a depression system (battery-powered), which is configured to maintain a negative pressure inside the inner chamber of the biocontainment cabin enclosed between the lower tank 323 and the shell 324.

### Additional Device According to a Third Functional Type

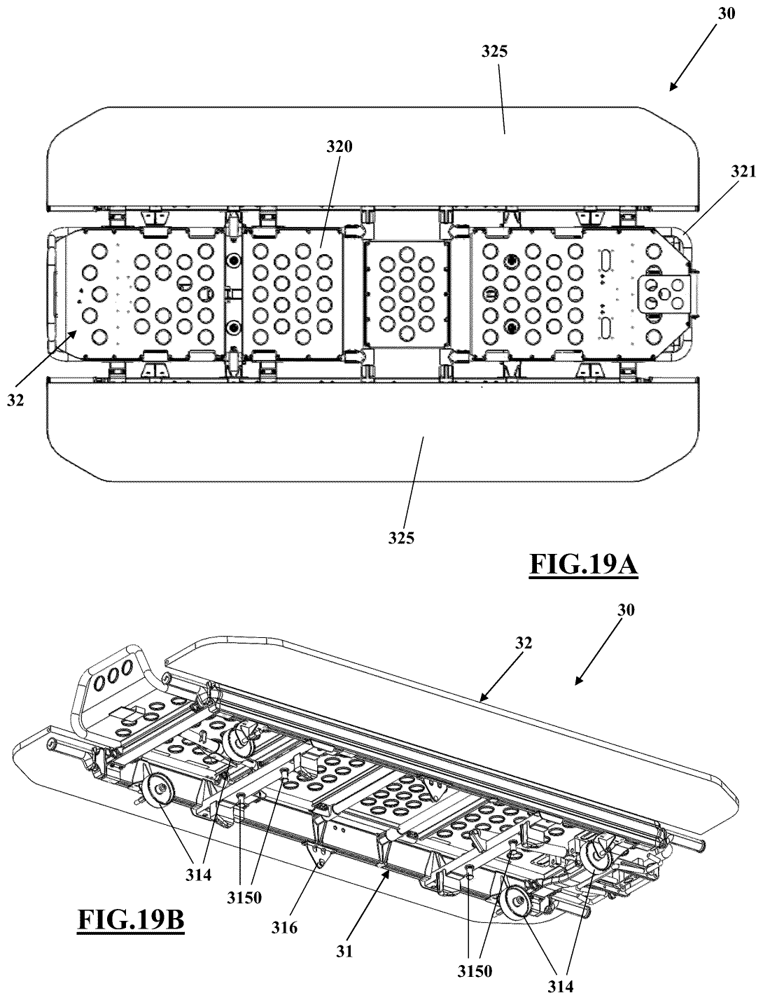

A third type of additional devices 30 is formed by a bariatric stretcher, as shown in FIGS. 19A and 19B.

The third type of additional devices 30 is studied and designed, for example, for transporting bariatric patients, preferably in a lying position, for example in circumstances of intensive care (ICU) or emergency therapy.

In such a case, the support device 32 comprises a rest platform 320, for example perforated, supported by a perimeter small tubular frame 321 (stably mounted on the load-bearing structure 31 described above).

The rest platform 320, e.g. formed by several plates placed side by side along the longitudinal axis of the support device 32 or monolithic, is e.g. rigid (preferably but not in a limiting manner coated on the top with a soft/resilient layer) or flexible.

The rest platform 320 might, in certain applications, be foldable, for example to support the patient in a semi-recumbent or sitting position.

To each side (longitudinal) of the small tubular frame 321 there is rotatably coupled a sideboard 325, which is configured to oscillate between at least two end stroke positions, including a first end position, in which the sideboard is substantially orthogonal to the rest platform 320 (and rises from it), and a second end stroke position, in which the sideboard is substantially parallel to the rest platform 320 (and coplanar with it, i.e. so that its upper surface is coplanar to the upper surface of the rest platform 320).

When the sideboards 325 are in the second end stroke position they act as a lateral extension for the rest platform 320 (and therefore, if necessary, they help to support the bariatric patient).

For example, each sideboard 325 could also be locked in one or more intermediate positions between the two end stroke positions, such as inclined by 30° and/or 60° with respect to the plane defined by the rest platform 320.

### Additional Device According to a Fourth Functional Type

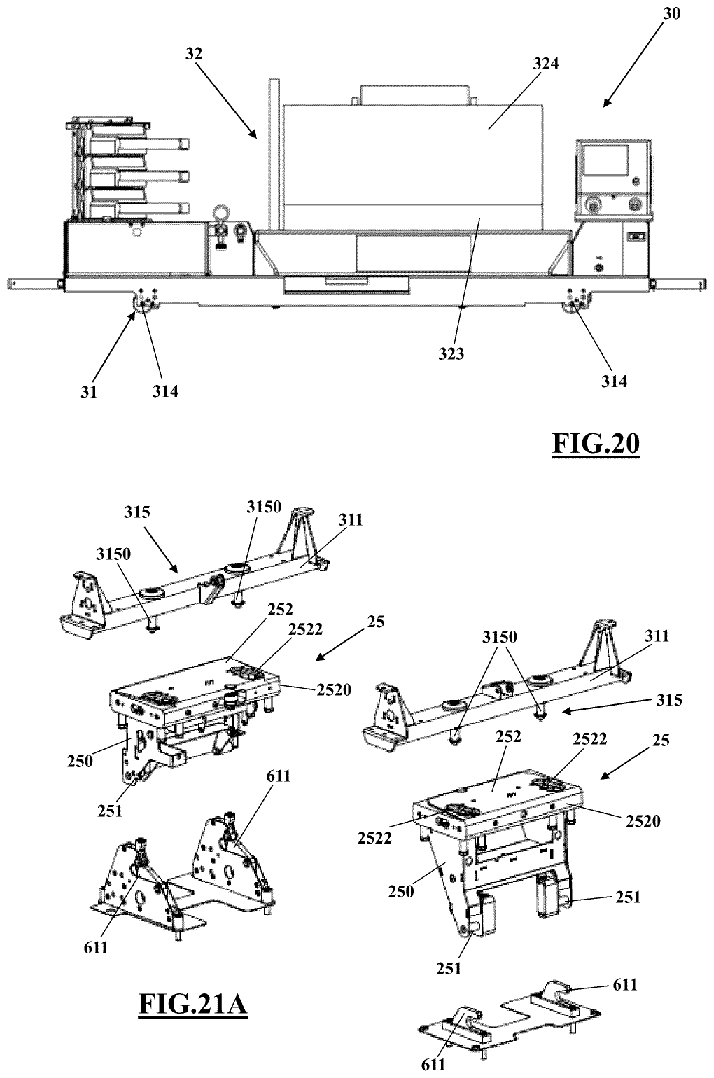

A fourth type of additional devices 30 is formed by a neonatal cot (or incubator), as shown in FIG. 20.

The fourth type of additional devices 30 is studied and designed, for example, for transporting neonatal patients, preferably in a lying position, for example in circumstances of intensive care (ICU) or emergency therapy, so as to be able to isolate the transported patient from the surrounding environment.

In this case, the support device 32 comprises (or consists of) a rest platform 320, for example defined by a mat or the like, supported by a lower perimeter tank 323 (stably mounted on the load-bearing structure 31) and closed at the top by at least one upper shell 324 that is closed (hermetically) on the lower tank.

The shell 324 is for example made of rigid material.

The shell 324 is preferably made of an optically transparent material (e.g. plastic material).

In addition, the shell 324 might have one or more removable or openable (flap-like) portions, to allow access to the patient (e.g. to perform resuscitation or cleaning operations or otherwise).

Still, the shell 324 might have one or more portholes that can be opened and closed (tightly) by respective (circular) hatches, e.g. double hatches (provided with single-patient gloves).

Still, the support device 32 according to this fourth functional type of additional devices 30 comprises a ventilation/oxygenation system, e.g. battery-powered (and provided with filtering systems for the incoming air and the outgoing exhaled air), and possibly a temperature control and conditioning system (battery-powered), within the inner chamber of the neonatal cot enclosed between the lower tank 323 and the shell 324.

The patient transport system 10 comprises a plurality of additional devices 30, wherein the plurality of additional devices 30 may be variously configured according to the needs, for example defined by:
at least one additional device 30 of each type (first, second, third and fourth) described above, or
a plurality of additional devices 30 that are homologous to one another (i.e. belonging to the same functional type, e.g. among the four types described above);
a plurality of additional devices 30 belonging to at least two different functional types, e.g. among the four types described above); or
various possible configurations.

The combination of any undercarriage 20 (between the first undercarriage 20 and the second undercarriage 20, described above) and any additional device 30 (chosen from the first, second, third and fourth functional types, described above) defines, overall, a patient transport equipment 50.

In practice, the patient transport system 10 is formed by at least one patient transport equipment 50 that can be variously configured according to the needs. Preferably, the patient transport system 10 is formed by a multiplicity of patient transport equipment 50 each of which can be variously configured according to the needs.

Each additional device 30 comprises, for example, an ID identification code, for example tags, for example RFID (or QR-Code or otherwise).

This ID identification code is, for example, applied to the load-bearing structure 31 and/or to the support device 32, for example in a lower surface thereof facing the upper surface of the support frame 21 of each (first) undercarriage 20.

The ID identification code is placed so as to be read by the reader S18 (e.g., the radio reader or the optical reader) of the sensor arrangement, when the additional device 30 is (stably) coupled to the (first) undercarriage 20.

For example, the ID identification code is indicative of the functional type of the additional device 30 (and/or includes other useful information relating to the additional device 30) to which it is applied.

As described above, each additional device 30 comprises the same fixing block 315 and each undercarriage 20 comprises a (respective) same (fixing assembly 25 and a same) fixing arrangement 252 configured to engage, in a releasable manner, with a (any) fixing block 315 of any one of the additional devices 30.

Once the coupling between a first undercarriage 20 and any one of the additional devices 30 has taken place, the sensor S17 can detect the correct locking of the locking element 2523, i.e. it detects the correct (reciprocal) positioning between the locking element 2523 and the respective coupling pin 3150 that engages it.

In this case, the electronic control unit 272 (receiving the signal from the sensor S17) gives consent to handling the first undercarriage 20.

Still, the reader S18 reads the ID identification code of the additional device 30 coupled to the first undercarriage 20.

In this case, the electronic control unit 272 (receiving the information from the reader S18) can be configured to:
determine the functional type of the additional device 30 mounted on the (first) undercarriage 20 (based on the ID identification code read by the reader S18); and
check at least one operating parameter of the actuation arrangement on the basis of the determined functional type.

For example, the operating parameter could be chosen between the maximum stroke of the pair of front legs 22 and of the pair of rear legs 23 (for example by varying the end stroke positions), the possibility and/or the inclination intensity of the support frame 21 with respect to the horizontal, the height from the ground of the support frame 21, the movement speed (lifting/lowering) of the pair of front legs 22 and/or of the pair of rear legs 23 and other possible operating parameters.

The system for loading/unloading 100 further comprises a loading/unloading apparatus 60, which is fixed to or carried by the ambulance V.

The loading/unloading apparatus 60 comprises a longitudinal guide 61, which is configured to be placed on the loading surface L of the ambulance V (parallel to the longitudinal axis of the ambulance).

The guide 61 comprises, for example, a fixed rail 610, which is fixed (e.g. bolted) to the loading surface L.

The length of the fixed rail 610 is substantially equal to the axial length of the patient transport equipment 50 (which is intended for loading/unloading).

Further, the fixed rail 610 has a rear end arranged at or proximal to the rear opening of the ambulance V and an opposing front end arranged proximal to the driver's cab of the ambulance V.

Safety couplings 611 (so-called hooks 20g or 10g) rise from the fixed rail 610 and/or from the loading surface and which are configured to lock and hold the patient transport equipment 50 locked, once it is completely loaded within the loading compartment of the ambulance V.

In detail, at least one pair of front safety couplings 611 project from the upper surface of the fixed rail 610, i.e. they are distal from the rear opening of the ambulance V, which are (mutually symmetrical with respect to a vertical longitudinal median plane of the fixed rail 610 e) configured to couple (snap) to the (front) coupling bodies 251 of the undercarriage 20 of the patient transport equipment 50.

Each safety coupling 611 of the pair of front safety couplings 611 is “C” shaped with a concavity facing the rear opening of the ambulance V, so as to define an access opening (inside the concavity) facing the rear opening of the ambulance V.

Furthermore, each safety coupling 611 of the pair of safety couplings 611 front comprises a retaining body, which is movable from a disengagement position, in which it opens the aforesaid access opening, to an engagement position, in which it closes at least partially the access opening, as opposed to elastic means (such as a spring).

The retaining body is shaped so as to have an anti-symmetrical or anti-slip conformation, in which
a rear sidewall of the retaining body (facing the rear opening of the ambulance V) defines a cam profile shaped so as to cause the passage from the engagement position to the disengagement position by a horizontal thrust acting thereon and directed parallel to the direction of development of the fixed rail 610 in the direction of introduction of the patient transport equipment 50 on the loading surface L of the ambulance V, and
an opposing front sidewall of the retaining body defines an anti-slip abutment surface for the (front) coupling body 251 of the undercarriage 20.

For example, the retaining body of the safety couplings 611 is configured so as to be releasable from the release piston 2510 of the (front) rigid constraint body 250, for example in the passage from the upper inactive position to the lower active position of the same (commanded by the electronic control unit 272 (in response to an operator stimulus).

In addition, at least one pair of rear safety couplings 611 project from the upper surface of the fixed rail 610, i.e. they are proximal to the rear opening of the ambulance V, which are (mutually symmetrical with respect to a vertical longitudinal median plane of the fixed rail 610 and) configured to couple (snap) to the (front) coupling bodies 251 of the undercarriage 20 of the patient transport equipment 50.

Each safety coupling 611 of the pair of rear safety couplings 611 is “C” shaped with a concavity facing the rear opening of the ambulance V and, so as to define an access opening (inside the concavity) facing the rear opening of the ambulance V (and always open).

When each safety hook 611 is coupled to the respective coupling body 251, each rigid constraint body 250 of the undercarriage 20 interconnects (directly) the safety hook 611 (and thus the loading surface L of the ambulance) with the additional device 30, defining a (short) direct kinematic chain, on which the stresses between ambulance V and additional device 30 are discharged.

In practice, the rigid connection defined by the rigid constraint body 250 allows the additional device 30 to be safely and stably connected to the safety hooks 611 (which are in turn fixed to the loading surface L of the ambulance V), with the effect that the additional device 30 is as if it were rigidly connected to the loading surface L of the ambulance V during the running phases of the ambulance itself. The connection between the safety hooks 611 and the load-bearing structure 31 of the additional device 30, through the rigid constraint bodies 250 of the undercarriage 20, opposes any stresses due to the motion of the ambulance V and/or the inertia on the additional device 30, by preventing axial forward sliding as well as lifting/rotations (e.g. during braking of the ambulance V) or backward sliding (e.g. during accelerations of the ambulance V), as well as preventing twisting or swinging (which may be due to side impacts suffered by the ambulance V). To facilitate loading and unloading the patient transport equipment 50, the guide 61, for example, may comprise an intermediate slide 612, which is slidingly associated (superiorly) with the fixed rail 610, along a sliding direction parallel to the longitudinal axis of the fixed rail 610 itself.

The slide 612, for example, is substantially half long the length of the fixed rail 610.

The slide 612 has a rear end arranged proximal to the rear opening of the ambulance V and an opposing front end arranged proximal to the driver's cab of the ambulance V.

For example, the slide 612 is configured to slide (with free sliding, i.e. not actuated) along the fixed rail 610 between two end positions, including a front end position, wherein for example the front end of the slide 612 is substantially placed at the front end of the fixed rail 610, and a rear end position, wherein for example the rear end of the slide 612 projects axially with respect to the rear end of the fixed rail 610 (by a stretch substantially equal to half the length of the slide 612), preferably so as to be able to project substantially outside the loading surface L (and therefore the loading compartment) of the ambulance V.

Between the two end positions, the slide 612 travels a stroke equal substantially to ¾ of the length of the fixed rail 610.

The guide 61 further comprises one or more coupling elements 613, interposed between the slide 612 and the fixed rail 610, configured to (temporarily) stop the slide 612 at corresponding axial stop positions along the travel between the two end positions and/or at each of said end positions.

In particular, the guide 61 has a front coupling element 613 configured to (temporarily) stop the slide 612 in the rear end position.

Further, the guide 61 has an intermediate coupling element 613 configured to (temporarily) stop the slide 612 at an intermediate stop position between the front end position and the rear end position, for example wherein the rear end of the slide 612 is placed substantially at the rear end of the fixed rail 610.

For example, the intermediate coupling element 613 defines a unidirectional constraint that does not allow the slide 612 to slide in the direction of approach to the rear end position (but it allows the slide 612 to slide in the direction of approach to the front end position).

For example, the coupling elements 613 are configured so as to be releasable from the release arrangement of the undercarriage 20, i.e., from the second pin 267 (in the passage from the retracted position to the extracted position thereof, when the second pin 267 is at, that is superimposed in plan, on a release appendage of the coupling element 613 which emerges above the slide 612, at least when it couples with the fixed rail 610) and/or from a cam system which can be actuated by a support coupling 62 (described in detail below).

The loading/unloading apparatus 60 further comprises a support coupling 62, which is slidingly (superiorly) connected to the guide 61 along a sliding direction parallel to the longitudinal axis of the guide itself.

The support coupling 62 is configured to receive with releasable coupling the coupling body 26, i.e. the coupling head 260, of the undercarriage 20, as will be better described below, and/or support at least partially the undercarriage 20 and/or the patient transport equipment 50 as a whole (performing an anti-tipping function for the same).

The support coupling 62 defines a concave seat formed by a rear wall (orthogonal to the longitudinal axis of the guide 61), two lead-in side walls, having a free rear end and a rear end which is joined to the rear wall, and a lower wall (which is joined to the side walls and to the rear wall).

In practice, the support coupling 62 is defined by a box-like body open superiorly and anteriorly and closed laterally by the side walls, at the rear by the rear wall and at the bottom by the lower wall.

The lead-in side walls preferably converge towards the rear wall, so that the free front ends are at a greater distance apart than the distance between the rear ends.

The concave seat contained between the lead-in side walls, the rear wall and the lower wall delimits an internal volume within which a coupling seat 620 is contained.

The support coupling seat 620 is configured to define a snap coupling, releasable, with the coupling head 260 of the undercarriage 20 of the patient transport equipment 50.

The support coupling seat 620, in this case, comprises a first lower coupling 621, which is for example fixed with respect to the support coupling seat 620.

The free upper end of the first coupling 621 is, for example, associated with a revolution member, such as a roller (rotatably associated with the first coupling 621 with respect to a rotation axis parallel to the loading surface L and orthogonal to the sliding direction).

The roller is configured to roll on the coupling head 260 during the coupling and release operations.

The support coupling seat 620 further comprises a second upper coupling 622, which is movable with respect to the support coupling seat 620.

The second coupling 622 is, for example, movable from a rear position to a front position, for example in contrast to an elastic thrust force, preferably exerted by a thrust spring, for example helical.

Preferably, the second coupling 622 is associated in a tilting manner with the support coupling seat 620, for example with the rear wall thereof (and facing anteriorly therefrom), around a second (horizontal) tilting axis orthogonal to the sliding direction of the support coupling 62.

The free upper end of the second coupling 622 is, for example, associated with a revolution member, such as a roller (rotatably associated with the second coupling 622 with respect to a rotation axis parallel to the second tilting axis). The roller is configured to roll on the coupling head 260 during the coupling and release operations.

In practice, the coupling support seat 620 is defined between the first coupling 621 and the second coupling 622 (i.e., between the two rollers) and is selectively configurable between two operating positions, including:
a first open configuration, in which the second coupling 622 is in the rear position (and the distance between the rollers is such as to allow the passage of the maximum diameter zone of the coupling head 260); and
a second closed configuration, in which the second coupling 622 is in the front position (and the distance between the rollers is minimal and such as to prevent the passage of the maximum diameter zone of the coupling head 260).

The second coupling 622, moreover, is such as to define an anti-tipping constraint for the undercarriage 20 and/or for the patient transport equipment 50, that is it is such as to oppose a vertical thrust directed upwards.

For example, the second coupling 622 is configured so as to be releasable from the release arrangement of the undercarriage 20, i.e., from the first pin 265 (in the passage from the retracted position to the extracted position thereof, when the first pin 265 is, i.e., horizontally aligned and at a predetermined axial distance, at a release appendage of the second coupling 622, at least when it couples the coupling head 260).

The support coupling 62, for example, has an axial length substantially less than half of the length of the slide 612 to which it is fixed, for example equal to ¼ of the length of the slide 612.

The support coupling 62 has a front (open) end arranged proximal to the rear opening of the ambulance V and an opposing rear end, defined by the rear wall, arranged proximal to the driver's cab of the ambulance V.

For example, the support coupling 62 is configured to slide (with free sliding, i.e., not actuated) along the slide 612 between two end positions, including one front end position, wherein, for example, the rear end of the support coupling 62 is placed substantially at the front end of the slide 612, and one rear end position, wherein, for example, the front end of the support coupling 62 is placed substantially at the rear end of the slide 612.

Between the two end positions, the support coupling 62 travels a stroke equal substantially to ¾ of the length of the slide 612.

At least one between the slide 612 and the support coupling 62 further comprises one or more coupling elements 623, interposed between the slide 612 and the support coupling 62, configured to (temporarily) stop the support coupling 62 in corresponding axial stop stations along the travel between the two end positions and/or at each of said end positions.

In particular, the slide 612 has a rear coupling element 623 configured to (temporarily) stop the support coupling 62 in the rear end position and a front coupling element 623 configured to (temporarily) stop the support coupling 62 in the front end position.

For example, the coupling elements 623 are configured so as to be releasable from the release arrangement of the undercarriage 20, that is from the second pin 267 (in the passage from the retracted position to the extracted position thereof) and/or from cam elements fixed to the fixed rail 610 and intended to come into contact with the coupling element 623 during the sliding of the slide 612 on the fixed rail 610 from the front end position to the rear end position.

The rear coupling element 623 is, for example, released by the second pin 267. The front coupling element 623 is, for example, released by means of such cam elements (i.e. a linear cam).

The loading/unloading apparatus 60 may comprise at least a first sensor configured to detect when the slide 612 is in its rear end position and/or in its front end position (with respect to the fixed rail 610) and/or a second sensor configured to detect when the support coupling 62 is in its front end position and/or in its rear end position (with respect to the slide 612).

In addition, the loading/unloading apparatus may comprise a further electronic control unit (not illustrated) also having an interface module, e.g. defined by a visual/acoustic beacon and/or configured to connect to the control module 27 (i.e. to the electronic control unit 272 and/or to the user interface 271) of the undercarriage 20, e.g. wirelessly.

In view of the above, the operation of the patient transport system 10 and/or the system for loading/unloading 100 is as follows.

First, an operator configures a patient transport equipment 50 according to the needs.

To do this, it is sufficient to choose the additional device 30 of the desired functional type and (through the action of two operators) position it on top of the desired undercarriage 20.

Once the chosen additional device 30 has been superimposed on the chosen undercarriage 20, it is sufficient to mount one on top of the other, e.g. to insert axially the fixing block 315 (i.e. the coupling pins 3150) to the fixing arrangement 252 (i.e. the coupling seats 2521, at the enlarged axial section of the access slots 2522).

When the coupling pins 3150 are inserted into the respective coupling seats 2521, the additional device is slid onto the upper surface of the support frame 21 until the coupling pins 3150 are locked in the correct coupling position by the locking elements 2523.

In case the chosen undercarriage 20 is a first undercarriage 20, the sensor S17 detects the correct coupling between the coupling pins 3150 and the coupling seat 2521 and sends the information to the electronic control unit 272 that allows the next working steps of the patient transport equipment 50 now assembled (and formed by the undercarriage 20 and the additional device 30 mounted thereon). Still, the reader S18 detects the ID identification code of the additional device 30 mounted on the undercarriage 20 and sends the information to the electronic control unit 272, which controls/sets the various operating parameters according to the functional type of additional device 30 mounted.

At this point, the patient transport equipment 50 is ready for use.

In case the undercarriage 20 is a second undercarriage 20, the loading/unloading operations of the patient transport equipment 50 onto/from the loading surface L of the ambulance V are performed manually by one or both operators, as known. In case the undercarriage 20 is a first undercarriage 20, on the other hand, the electronic control unit 272 of the undercarriage 20 is configured to perform (and/or assist in performing) a loading sequence of the patient transport equipment 50 on the loading surface L of the ambulance V, i.e. on the loading/unloading apparatus 60.

While performing the loading sequence, the operator may (or must) hold down a loading button and/or initiate a loading sequence via the user interface 271, the release of such a button safely locks any handling of the patient transport equipment 50.

First, an operator (or the electronic control unit of the loading/unloading apparatus) checks that the slide 612 is in its rear end position and locked therein by the rear coupling element 613 and the support coupling 62 is in its rear end position and locked therein by the rear coupling element 623.

When the loading sequence is activated, first the support frame 21 of the undercarriage 20 is brought to a predetermined loading height by actuating the first front actuator 225 and/or the second rear actuator 235.

This height is configured so that the coupling head 260 is at a height greater than the lower wall of the support coupling 62 (but less than the maximum height of the rear wall thereof).

At this point, the operator guides the patient transport equipment 50 so as to bring the coupling head 260 within the support coupling 62, for example guided by the lead-in side walls thereof.

When the coupling head 260 enters the support coupling 62 it is pressed by the operator against the rear wall thereof (and/or against the second coupling 622), and this pressure brings the coupling head 260 from its front end stroke to its rear end stroke.

When the coupling head 260 reaches its rear end stroke, the first limit switch sensor S10 detects this position and, for example, the first proximity sensor S9 recognises that the coupling head 260 is in abutment against the rear wall of the support coupling 62 (and not against an occasional obstacle), consequently, the electronic control unit 272 detects the correct positioning of the coupling head 260 in the support coupling 62 based on the (electrical) signal received by the first limit switch sensor S10.

At this point, the electronic control unit 272 gives its consent to the next steps of the loading sequence.

In particular, the electronic control unit 272 commands the first front actuator 225 and the first rear actuator 235 so as to lower the undercarriage 20, i.e. the support frame 21 thereof, vertically.

When the coupling head 260 is pressed by the lowering against the lower wall of the support coupling 62 within the coupling seat 620 thereof, such pressure brings the coupling head 260 from its lower end stroke to its upper end stroke. When the coupling head 260 reaches its upper end stroke, the second limit switch sensor S11 detects this position and, consequently, the electronic control unit 272 detects the correct positioning of the coupling head 260 in the support coupling 62 based on the (electrical) signal received by the second limit switch sensor S11.

In practice, the lifting of the coupling head 260 from the lower end stroke to the upper end stroke is indicative of (a height of the support frame 21 and/or) a load bearing on the coupling body 26 (i.e. on the coupling head) detected by means of the second limit switch sensor S11.

In fact, when the load bearing on the coupling head 260 is lower than a predetermined loading value, the coupling head 260 does not reach the upper end stroke, whereas when instead the load bearing on the coupling head 260 exceeds or equals the predetermined loading value, the coupling head 260 reaches the upper end stroke.

When the first limit switch sensor S10 and the second limit switch sensor S11 detect that both the rear end stroke and the upper end stroke of the coupling head 260 have been reached, the coupling head 260 has entered the coupling seat 620 and is retained therein between the first coupling 621 and the second coupling 622.

The electronic control unit 272 is configured to query the third distance sensor S12, in order to check the correct alignment/parallelism of the undercarriage 20 (i.e. the support frame thereof) with respect to the guide 61.

At this point, the electronic control unit 272, when it receives the signal from the second limit switch sensor S11, is configured to operate the lifting of the pair of front legs 22 (up to the raised angular end stroke position), by actuating the first front actuator 225, based on the indicative signal detected.

The electronic control unit 272, moreover, is configured to determine an inclination of the support frame 21 with respect to the slide 612 (during the lifting of the pair of front legs 22), for example by means of the third distance sensor S12 and, to command the lifting/lowering of the pair of rear legs 23, by actuating the first rear actuator 235, to keep the support frame 21 parallel to the rest plane/ground (and/or to the loading surface L).

When the pair of front legs 22 is in its raised angular end stroke position, the electronic control unit 272 can first confirm/check the reaching thereof by querying the first front angle sensor S1.

In addition, the electronic control unit 272 is configured to command and actuate the release arrangement, for example by commanding the second pin 267 to move to its extracted position, so as to unlock the locking arrangement, i.e. the rear coupling element 623 (to allow the support coupling 62 to slide on the slide 612 towards its front end position).

The operator can then push the patient transport equipment 50 forward.

As soon as the advancement of the patient transport equipment 50 begins, the electronic control unit 272 can check that the slide 612 is free to slide on the fixed rail 610, for example by means of the second distance sensor S8, and commands the second pin 267 to return to its retracted position.

At this point, the operator can push the patient transport equipment 50 horizontally until the support coupling 62 reaches its front end position.

When the support coupling 62 reaches its front end position on the slide 612 it unlocks (by means of a special mechanism) the coupling element 613 allowing the slide 612 to slide on the fixed rail 610 (from the front end position to the rear end position).

At this point, the electronic control unit 272 checks the position of the patient transport equipment 50 with respect to the loading surface L, in particular, it queries the first distance sensor S7.

In particular, the electronic control unit 272 on the basis of the signal received from the first distance sensor S7 determines if/when the pair of front legs 22 are fully loaded onto (and superimposed on) the loading surface L, i.e. if at least the front half of the patient transport equipment 50 is fully loaded onto (and superimposed on) the loading surface L.

Once the electronic control unit 272 has determined that the front half of the patient transport equipment 50 is fully loaded onto (and superimposed on) the loading surface L, it is configured to command the lifting of the pair of rear legs 23 (by detaching them from the ground), by actuating the first rear actuator 235, up to their raised angular end stroke position.

When the pair of rear legs 23 is in its raised angular end stroke position, the electronic control unit 272 can first confirm/check the reaching thereof by querying the first front angle sensor S2.

When the pair of rear legs 23 is raised from the ground, the load of the patient transport equipment 50 is supported by the loading surface L and by the support coupling 62 (i.e., by the second coupling 622, which has an anti-tipping function). Furthermore, the intermediate coupling element 613 prevents the slide 612 and the patient transport equipment 50 loaded thereon from sliding in the direction of approach to the rear end position.

When the pair of rear legs 23 is in its raised angular end stroke position, the operator can advance the patient transport equipment 50 (by pushing it horizontally), sliding it until the slide 612 is brought to its front end position and locked there by the coupling element 613 (and the support coupling 62 is already in its front end position).

In this position, the patient transport equipment 50 couples (automatically), through its coupling bodies 251, with the safety hooks 611 of the guide 61 (retaining the support element 62 in its front end position and the slide 612 in its front end position).

The electronic control unit 272 is configured to detect the successful and correct coupling between the coupling bodies 251 and the safety hooks 611, for example by querying each second proximity sensor S13 and by receiving from it a respective signal of successful coupling.

For example, the electronic control unit 272 is configured to finish the loading sequence on the basis of a signal emitted and received by each second proximity sensor S13 and indicative of the successful coupling.

As mentioned, in such a coupling configuration (cf. FIG. 28) the patient transport equipment 50 is stably fixed to the loading surface L of the ambulance V and the rigid constraint body 250 stably constrains the additional device 30 to the safety couplings 611 through a (short) safe kinematic chain for the transported patient.

The electronic control unit 272 is configured to perform (and/or assist in performing) an unloading sequence of the patient transport equipment 50 from the loading surface L of the ambulance V, i.e. from the loading/unloading apparatus 60. While performing the unloading sequence, the operator may (or must) hold down an unloading button and/or initiate an unloading sequence via the user interface 271, the release of such a button safely locks any handling of the patient transport equipment 50.

First, the operator and/or the electronic control unit 272 operates the mechanical release of the coupling bodies 251 from the safety hooks 611, for example by commanding the release piston 2510.

The electronic control unit 272 is configured to detect the successful and correct release between the coupling portions 251 and the safety hooks 611, for example by querying each second proximity sensor S13 and by receiving from it a respective signal of successful release.

At this point, the operator pulls the patient transport equipment 50 axially and posteriorly with respect to the ambulance V until the slide 612 is constrained by the intermediate coupling element 613 (which locks its sliding towards the rear end position).

At this point, the electronic control unit 272 checks the position of the patient transport equipment 50 with respect to the loading surface L, in particular, it queries the first distance sensor S7.

In particular, the electronic control unit 272 on the basis of the signal received from the first distance sensor S7 determines if/when the pair of rear legs 23 are fully unloaded from (misaligned in plan from) the loading surface L, i.e. if at least the rear half of the patient transport equipment 50 is fully unloaded from (and misaligned in plan from) the loading surface L.

Once the electronic control unit 272 has determined that the rear half of the patient transport equipment 50 is fully unloaded from (and misaligned in plan from) the loading surface L, the same electronic control unit 272 is configured to command the lowering of the pair of rear legs 23 (until the rear wheels 231 contact the ground), by actuating the first rear actuator 235.

The electronic control unit 272 is configured to determine a correct rest on the ground of the rear wheels 231 based on a signal received from a sensor of the sensor arrangement, for example from the rear pressure sensor S15 or from the third distance sensor S12 or from the inclinometer and/or gyroscope and/or accelerometer S16.

For example, the electronic control unit 272 can be configured to detect, via the rear pressure sensor S15, a pressure value (in the hydraulic circuit of the first rear actuator 242) and compare this pressure value with a reference value thereof.

If the pressure value exceeds this reference value, the electronic control unit 272 is configured to determine the correct rest on the ground of the rear wheels 231. Alternatively or additionally, the electronic control unit 272 may be configured to detect via third distance sensor S12 and/or via the inclinometer and/or gyroscope and/or accelerometer S16 a change in inclination of a portion of the stretcher 20 (e.g. of the support frame 21) and determine the correct rest on the ground of the rear wheels 231 as a function or based on the detected change in inclination. Once the correct rest on the ground of the rear wheels 231 has been determined, the electronic control unit 272 is configured to stop the lowering of the pair of rear legs 23 (by stopping the first rear actuator 235).

At this point, the electronic control unit 272 is configured to command and actuate the release arrangement, for example by commanding the second pin 267 to move to its extracted position, so as to unlock the locking arrangement, i.e. the intermediate coupling element 613 (to allow the slide 612 to slide on the fixed rail towards its rear end position).

The operator, therefore, can pull the patient transport equipment 50 and then the slide 612 towards the rear end position and, the cam element on the fixed rail 610 releases the front locking element 623 allowing the support coupling 62 to be able to move towards the rear end position.

When the support coupling 62 (and the slide 612) arrives at its rear end position and is locked therein by the front coupling element 623, the electronic control unit 272 is configured to detect this position, for example by querying the second distance sensor S8 (which detects the distance of the patient transport equipment 50 from the ground).

At this point, the electronic control unit 272 is configured to command the lowering of the pair of front legs 22 by actuating the first front actuator 225. The electronic control unit 272 is, for example, configured to stop the lowering of the pair of front legs 22 as a function of a signal received from the second limit switch sensor S11.

In particular, the lowering of the pair of front legs 22 (when they start to touch the ground) causes the lowering of the coupling head 260 from the upper end stroke to the lower end stroke and this lowering is indicative of (a height of the support frame 21 and/or) a load no more bearing on the coupling body 26 (i.e. on the coupling head) detected by means of the second limit switch sensor S11.

In fact, when the load bearing on the coupling head 260 is lower than a predetermined loading value, the coupling head 260 moves to its lower end stroke.

In this position, the load of the patient transport equipment 50 placed on the pair of front legs 22 (and pair of rear legs 23) and frees the coupling head 26.

In addition, the electronic control unit 272 is configured to command and actuate the release arrangement, for example by commanding the first pin 265 to move to its extracted position, so as to unlock the coupling between the coupling head 260 and the coupling seat 620, i.e. by unlocking the second coupling 622, so as to be able to free the patient transport equipment 50 from the loading/unloading apparatus 60 and freely move it.

The invention thus conceived is susceptible to several modifications and variations, all falling within the scope of the inventive concept.

Moreover, all the details can be replaced by other technically equivalent elements.

In practice, the materials used, as well as the contingent shapes and sizes, can be whatever according to the requirements without for this reason departing from the scope of protection of the following claims.

1. A patient transport system that comprises:
at least one mobile undercarriage provided with rest wheels and equipped with a fixing arrangement;
a plurality of additional devices for supporting the patient, wherein the additional devices of the plurality of additional devices are structurally different from each other;
wherein each additional device is equipped with a relative fixing block, wherein each fixing block is configured to engage selectively with the fixing arrangement of the undercarriage in a releasable manner, so that any one of the additional devices can be selectively mounted on the same undercarriage by means of the connection between the fixing arrangement of the undercarriage with the fixing block of the respective additional device.

2. The transport system according to claim 1, comprising a fleet of said undercarriages each equipped with a respective fixing arrangement selectively engageable by any one of the fixing blocks of the plurality of additional devices, of which at least a first undercarriage of the fleet is of the semi-automatic or servo-assisted drive type and at least a second undercarriage of the fleet is of the manually operated type.

3. The transport system according to claim 1, wherein each fixing block is configured to engage releasably with the fixing arrangement by means of a snap coupling.

4. The transport system according to claim 3, wherein the fixing arrangement comprises at least one coupling seat and each fixing block comprises at least one coupling pin suitable for engaging, in a snap releasable manner, with the coupling seat.

5. The transport system according to claim 4, wherein the coupling seat comprises a lead-in and guide section for the coupling pin.

6. The transport system according to claim 4, wherein the coupling seat comprises a manually operable snap locking element for the release.

7. The transport system according to claim 6, wherein the coupling seat is manually operable by means of a release lever.

8. The transport system according to claim 1, wherein the fixing arrangement is rigidly fixed to a load-bearing frame of the undercarriage.

9. The transport system according to claim 1, wherein each fixing block is rigidly fixed to a load-bearing structure of the respective additional device.

10. The transport system according to claim 1, wherein the additional devices are chosen from the group consisting of a stretcher or gurney, a biocontainment cabin, a bariatric stretcher and a neonatal cot.

11. The transport system according to claim 1, wherein the plurality of additional devices comprises at least a first additional device of a first functional type chosen from the group consisting of a stretcher or gurney, a biocontainment cabin, a bariatric stretcher and a neonatal cot, and at least a second additional device of a second functional type different from the first functional type and chosen from the group consisting of a stretcher or gurney, a biocontainment cabin, a bariatric stretcher and a neonatal cot.

12. The transport system according to claim 1, wherein the undercarriage comprises a recognition system configured to recognize a functional type of the additional device that is mounted thereon.

13. The transport system according to claim 12, wherein the recognition system comprises a reader configured to read at least one identified code of the additional device and/or of the functional type of the additional device applied to each additional device.

14. The transport system according to claim 12, wherein the undercarriage comprises:
a load-bearing frame;
legs articulated to the load-bearing frame; and
at least one actuation arrangement configured to move the legs with respect to the load-bearing frame;
wherein the undercarriage further comprises:
an electronic control unit operationally connected to the recognition system and the actuation arrangement, wherein the electronic control unit is configured to:
determine the functional type of the additional device mounted on the undercarriage; and
check at least one operating parameter of the actuation arrangement on the basis of the determined functional type.
